(19) United States
(12) Patent Application Publication
(10) Pub. No.: US 2025/0251480 A1
(43) Pub. Date: Aug. 7, 2025

(54) DIRECTION OF ARRIVAL ESTIMATION SYSTEM AND SUPER-RESOLUTION DIRECTION OF ARRIVAL ESTIMATION DEVICE

(71) Applicant: Tsinghua University, Beijing (CN)

(72) Inventors: Xing Lin, Beijing (CN); Sheng Gao, Beijing (CN); Haiou Zhang, Beijing (CN)

(21) Appl. No.: 19/028,049

(22) Filed: Jan. 17, 2025

(30) Foreign Application Priority Data
Feb. 6, 2024 (CN) 202410171849.9

(51) Int. Cl. G01S 3/50; G01S 3/48

(52) U.S. Cl. CPC G01S 3/50; G01S 3/48

(57) ABSTRACT

The present disclosure relates to direction of arrival (DOA) estimation systems and super-resolution DOA estimation devices. An example system comprises a diffraction modulator configured to modulate phase distribution of electromagnetic fields of incident waves emitted by N signal sources to focus the incident waves on a detector, the DOAs corresponding to the signal sources within a preset angle range. The detector comprises a plurality of detection areas, the preset angle range comprising a plurality of angle intervals, each detection area corresponding to one angle interval. The detector is configured to measure intensity of an electromagnetic field in each detection area in response to the incident waves being focused on the detector to obtain an intensity measurement value of the electromagnetic field in each detection area, and determine the DOAs corresponding to the N signal sources based on angle intervals corresponding to N detection areas with greatest intensity measurement values.

### CROSS-REFERENCE TO RELATED APPLICATION

This disclosure claims priority to and benefit of Chinese Patent Application Serial No. 202410171849.9, filed Feb. 6, 2024, which is incorporated herein by reference in its entirety.

### TECHNICAL FIELD

The present disclosure relates to the technical field of radio direction finding, in particular to a direction of arrival (DOA) estimation system and a super-resolution DOA estimation device.

### BACKGROUND

The perception of the propagation direction of radio waves lays the foundation for communication, radar, navigation, etc. However, the existing DOA estimation technology uses array signal processing technology to measure the azimuth angle information of electromagnetic field signal sources. For example, the conventional multiple-signal classification (MUSIC) algorithm requires a large number of RF electronic circuits for demodulation, sampling, and complex algorithmic processing of multi-channel signals, which requires high hardware cost, algorithmic complexity, and massive data sampling, thus limiting its performance in terms of latency, power consumption, and cost.

### SUMMARY

In view of the foregoing, the present disclosure proposes a DOA estimation system and a super-resolution DOA estimation device, which can realize DOA estimation with low latency, low power consumption, and low cost.

According to a first aspect of the present disclosure, there is provided a direction of arrival, DOA, estimation system, comprising: a diffraction modulation module configured to modulate phase distribution of electromagnetic fields of incident waves emitted by N signal sources to focus the incident waves on a detection module, wherein N≥1 and DOAs corresponding to the signal sources are within a preset angle range; and the detection module comprising a plurality of detection areas, the preset angle range comprising a plurality of angle intervals, with each detection area corresponding to an angle interval; and the detection module being configured to measure intensity of an electromagnetic field in the each detection area in response to the incident waves being focused on the detection module to obtain an intensity measurement value of the electromagnetic field in the each detection area, and determine the DOAs corresponding to the N signal sources based on angle intervals corresponding to N detection areas with greatest intensity measurement values.

According to one possible implementation of the first aspect, each detection area in the detection module is provided with a detector configured to measure an intensity of an electromagnetic field in the detection area to which the detector belongs; the diffraction modulation module comprises at least one layer of cascaded passive intelligent surface, the passive intelligent surface being configured to perform phase modulation on the incident waves in a transmission mode, and the passive intelligent surface being made by mixing polytetrafluoroethylene, nano-ceramics, and fiberglass fabric; or the diffraction modulation module comprises a reconfigurable intelligent surface and a first control unit, the reconfigurable intelligent surface in the diffraction modulation module being configured to perform phase modulation on the incident waves in a reflection mode, and the first control unit being configured to apply a modulation voltage to the reconfigurable intelligent surface to realize the phase modulation of the incident waves.

According to one possible implementation of the first aspect, based on that the diffraction modulation module comprises the at least one layer of cascaded passive intelligent surface, the system further comprises: a beamforming module which comprising a reconfigurable intelligent surface and a second control unit, the reconfigurable intelligent surface in the beamforming module being configured to perform beamforming on the incident waves; and the second control unit, configured to determine a control voltage required for beamforming the incident waves emitted by the N signal sources based on the DOAs corresponding to the N signal sources and a direction angle corresponding to a signal receiver, and apply the control voltage to the reconfigurable intelligent surface in the beamforming module, whereby the reconfigurable intelligent surface in the beamforming module beamforms the incident waves and reflects the beamformed incident waves to the signal receiver.

According to one possible implementation of the first aspect, based on that the diffraction modulation module comprises the reconfigurable intelligent surface and the first control unit, the first control unit is further configured to: determine, based on the DOAs corresponding to the N signal sources and a direction angle corresponding to a signal receiver, a control voltage required for beamforming the incident waves emitted by the N signal sources, and apply the control voltage to the reconfigurable intelligent surface in the diffraction modulation module, whereby the reconfigurable intelligent surface in the diffraction modulation module beamforms the incident waves and reflects the beamformed incident waves to the signal receiver.

According to one possible implementation of the first aspect, the DOAs corresponding to the N signal sources determined by the detection module comprise intermediate values of the angle intervals corresponding to the N detection areas with the greatest intensity measurement values; and the DOA comprises a pitch angle and/or an azimuth angle, and the system further switches between estimation of the pitch angle and estimation of the azimuth angle by controlling the diffraction modulation module to rotate by 90°.

According to one possible implementation of the first aspect, an angular resolution corresponding to the preset angle range is smaller than a diffraction limit angle, and the angular resolution represents a magnitude of the angle interval.

According to the first aspect of the present disclosure, the incident wave is focused on the detection module by the diffraction modulation module modulating the phase distribution of electromagnetic field of the incident wave, and then the electromagnetic field intensity in each detection area is measured by the detection module, and the DOAs of the N signal sources are determined directly based on the angle intervals corresponding to the N largest detection areas. Compared with the prior art, the present disclosure eliminates the need for high-cost hardware components, complex algorithmic processing, and massive data sampling to achieve low latency, low power, and low cost DOA estimation.

According to a second aspect of the present disclosure, there is provided A direction of arrival, DOA, estimation system, comprising: a diffraction modulation module configured to modulate phase distribution of electromagnetic fields of incident waves emitted by N signal sources to focus the incident waves on a detection module, wherein N 1; the detection module comprising a plurality of detection areas, the detection module being configured to measure an intensity of an electromagnetic field in each detection area in response to the incident waves being focused on the detection module to obtain an intensity measurement value of the electromagnetic field in the each detection area, and send the intensity measurement value of the electromagnetic field in the each detection area to a control module; and the control module, configured to determine DOAs corresponding to the N signal sources based on the intensity measurement value of the electromagnetic field in the each detection area sent by the detection module.

According to one possible implementation of the second aspect, the DOAs corresponding to the signal sources are within a preset angle range, the preset angle range comprising a plurality of angle intervals, with the each detection area corresponding to an angle interval; and determining the DOAs corresponding to the N signal sources based on the intensity measurement value of the electromagnetic field in the each detection area sent by the detection module comprises: in response to N being 1, determining a greatest intensity measurement value and a second greatest intensity measurement value from the intensity measurement value of the electromagnetic field in the each detection area sent by the detection module, and determining whether a detection area to which the greatest intensity measurement value belongs is adjacent to a detection area to which the second greatest intensity measurement value belongs; and in response to the detection area to which the greatest intensity measurement value belongs being not adjacent to the detection area to which the second greatest intensity measurement value belongs, the DOAs corresponding to the signal sources are determined based on an angle interval corresponding to the detection area to which the greatest intensity measurement value belongs.

According to one possible implementation of the second aspect, determining the DOAs corresponding to the N signal sources based on the intensity measurement value of the electromagnetic field in each detection area sent by the detection module comprises: calculating an intensity ratio of the greatest intensity measurement value to the second greatest intensity measurement value in response to the detection area to which the greatest intensity measurement value belongs being adjacent to the detection area to which the second greatest intensity measurement value belongs; and determining the DOAs corresponding to the signal sources based on a relative magnitude between the intensity ratio and a preset decision coefficient, wherein the preset decision coefficient is obtained by calculating an intensity ratio between electromagnetic fields in adjacent detection areas corresponding to adjacent angle intervals in response to the DOAs of the incident waves being at an angle of intersection between the adjacent angle intervals.

According to one possible implementation of the second aspect, the DOAs corresponding to the signal sources comprise intermediate values of the angle intervals; and an angular resolution corresponding to the preset angle range is smaller than a diffraction limit angle, and the angular resolution represents a magnitude of the angle interval.

According to one possible implementation of the second aspect, the DOAs corresponding to the signal sources are within a preset angle range, the detection module comprises K detection areas, with K≥N, K intensity-angle characteristic curves corresponding to the K detection areas are pre-stored in the control module, and a k-th intensity-angle characteristic curve is used to represent a mapping relationship between a plurality of prior DOAs within the preset angle range and prior intensity values of electromagnetic fields of the incident waves having respective prior DOAs in a k-th detection area, respectively, with k∈[1,K]; wherein determining the DOAs corresponding to the N signal sources based on the intensity measurement value of the electromagnetic field in the each detection area sent by the detection module comprises: for each prior DOA within the preset angle range, calculating error values between K prior intensity values corresponding to the each prior DOA on the K intensity-angle characteristic curves and the intensity measurement values of the electromagnetic fields in the K detection areas sent by the detection module to obtain an error value corresponding to the each prior DOA, and selecting N prior DOAs with the smallest error value as the DOAs corresponding to the N signal sources.

According to one possible implementation of the second aspect, each detection area in the detection module is provided with a detector configured to measure an intensity of an electromagnetic field in the detection area to which the detector belongs; the diffraction modulation module comprises at least one layer of cascaded passive intelligent surface, the passive intelligent surface being configured to perform phase modulation on the incident waves in a transmission mode, and the passive intelligent surface being made by mixing polytetrafluoroethylene, nano-ceramics, and fiberglass fabric; or the diffraction modulation module comprises a reconfigurable intelligent surface, the reconfigurable intelligent surface in the diffraction modulation module being configured to perform phase modulation on the incident waves in a reflection mode.

According to one possible implementation of the second aspect, based on that the diffraction modulation module comprises the at least one layer of cascaded passive intelligent surface, the system further comprises: a beamforming module comprising a reconfigurable intelligent surface, the reconfigurable intelligent surface in the beamforming module being configured to perform beamforming on the incident waves; and wherein the control module is further configured to determine a control voltage required for beamforming the incident waves emitted by the N signal sources based on the DOAs corresponding to the N signal sources and a direction angle corresponding to a signal receiver, and apply the control voltage to the reconfigurable intelligent surface in the beamforming module, whereby the reconfigurable intelligent surface in the beamforming module beamforms the incident waves and reflects the beamformed incident waves to the signal receiver.

According to one possible implementation of the second aspect, based on that the diffraction modulation module comprises a reconfigurable intelligent surface, the control module is further configured to: apply a modulation voltage to the reconfigurable intelligent surface in the diffraction modulation module to realize phase modulation of the incident waves; and/or determine a control voltage required for beamforming the incident waves emitted by the N signal sources based on the DOAs corresponding to the N signal sources and a direction angle corresponding to a signal receiver, and apply the control voltage to the reconfigurable intelligent surface in the diffraction modulation module, whereby the reconfigurable intelligent surface in the diffraction modulation module beamforms the incident waves and reflects the beamformed incident waves to the signal receiver.

According to one possible implementation of the second aspect, the DOA comprises a pitch angle and/or an azimuth angle, and the control module is further configured to control the diffraction modulation module to rotate by 90° to switch between estimation of the pitch angle and estimation of the azimuth angle.

According to a third aspect of the present disclosure, the incident wave is focused on the detection module by the diffraction modulation module modulating the phase distribution of electromagnetic field of the incident wave, the detection module measures the electromagnetic field intensity in each detection area and sends the electromagnetic field intensity measurement in each detection area to the control module, and the control module determines the DOA of the signal source based on the intensity measurement value of the electromagnetic field in each detection area, thus realizing DOA estimation with low latency, low power consumption, low cost, and higher-precision.

According to the third aspect of the present disclosure, there is provided a super-resolution direction of arrival, DOA, estimation device, comprising: a single first DOA estimation system configured to estimate DOAs in I angle intervals of a preset angle range, with I being a positive integer; and I second DOA estimation systems, wherein an i-th second DOA estimation system is configured to estimate DOAs in J sub-angle intervals of an i-th angle interval in the I angle intervals, with i∈[1, I] and J being a positive integer, wherein the first DOA estimation system and the second DOA estimation system are system according to the above first aspect or any possible implementation of the above first aspect, or systems according to the above second aspect or any possible implementation of the above second aspect.

According to one possible implementation of the third aspect, the first DOA estimation system is configured to control an m-th second DOA estimation system for estimating a DOA in an m-th angle interval to perform DOA estimation in response to estimating that the DOA corresponding to the signal source belongs to the m-th angle interval, with m∈[1, i]; and the m-th second DOA estimation system is configured to determine a sub-angle interval to which the DOA corresponding to the signal source belongs, and determine the DOA corresponding to the signal source based on the sub-angle interval to which the DOA corresponding to the signal source belongs.

According to one possible implementation of the third aspect, a magnitude of the angle interval is greater than or equal to a diffraction limit angle, and a magnitude of the sub-angle interval is less than the diffraction limit angle.

According to the third aspect of the present disclosure, a variety of DOA estimation systems may be used to perform coarse-to-fine DOA estimation based on the space-time multiplexing mechanism, which is able to realize super-resolution DOA estimation over a wide field of view and which has the advantages of low cost, low latency, and low power consumption.

Other features and aspects of the present disclosure will become evident in light of the following detailed description of exemplary embodiments with reference to the accompanying drawings.

### BRIEF DESCRIPTION OF THE DRAWINGS

The accompanying drawings included in and constituting a part of the description, together with the description, illustrate exemplary embodiments, features, and aspects of the present disclosure and serve to explain the principle of the present disclosure. The patent or application file contains at least one drawing executed in color. Copies of this patent or patent application publication with color drawings will be provided by the Office upon request and payment of the necessary fee.

FIG. 1 is a schematic diagram showing the basic working principle of a DOA estimation system according to an embodiment of the present disclosure.

FIG. 2 is a schematic diagram showing a DOA estimation system 200 according to an embodiment of the present disclosure.

FIG. 3 is a schematic diagram showing a detection module 202 according to an embodiment of the present disclosure.

FIG. 4a is a schematic diagram showing a DOA estimation system according to an embodiment of the present disclosure.

FIG. 4b is a schematic diagram showing a three-dimensional model of a DOA estimation system according to an embodiment of the present disclosure.

FIG. 4c is a schematic diagram showing a diffraction modulation module 201 according to an embodiment of the present disclosure.

FIG. 4d is a schematic diagram showing a programmable superatom in a reconfigurable intelligent surface according to an embodiment of the present disclosure.

FIG. 4e is a schematic diagram showing phase modulation of a reconfigurable intelligent surface 2011 in a reflection mode according to an embodiment of the present disclosure.

FIG. 5 is a schematic diagram showing an experimental apparatus according to an embodiment of the present disclosure.

FIG. 6 is a schematic diagram showing different estimation modes of a DOA estimation system according to an embodiment of the present disclosure.

FIG. 7 is a schematic diagram showing a two-dimensional estimation mode according to an embodiment of the present disclosure.

FIG. 8 is a schematic diagram showing an application scenario according to an embodiment of the present disclosure.

FIG. 9a is an entity schematic diagram of three layers of passive intelligent surfaces according to an embodiment of the present disclosure.

FIG. 9b is a schematic diagram showing a confusion matrix obtained by three layers of passive intelligent surfaces being experimented on all permutations and combinations of DOAs of dual-signal sources according to an embodiment of the present disclosure.

FIG. 10a is a schematic diagram showing phase distribution of an incident electromagnetic wave according to an embodiment of the present disclosure.

FIG. 10b, FIG. 10c, and FIG. 10d are schematic diagrams respectively showing three types of electromagnetic field intensity measurement results obtained by using three layers of passive intelligent surfaces according to an embodiment of the present disclosure.

FIG. 11 is a schematic diagram showing DOA estimation performance of three layers of passive intelligent surfaces in a broadband DOA estimation task with an incident wave frequency from 25 GHz to 30 GHz according to an embodiment of the present disclosure.

FIG. 12a and FIG. 12b are schematic diagrams respectively showing a confusion matrix and an energy matrix obtained from experiments on a single-signal source test dataset using three layers of passive intelligent surfaces according to an embodiment of the present disclosure.

FIG. 13a is a schematic diagram showing an energy matrix when synchronous DOA estimation of a base station and a user terminal is performed by using three layers of passive intelligent surfaces according to an embodiment of the present disclosure.

FIG. 13b is a schematic diagram showing signal amplitude detected at a user terminal antenna according to an embodiment of the present disclosure.

FIG. 14a is a schematic diagram showing phase distribution when a reconfigurable intelligent surface is used for DOA estimation according to an embodiment of the present disclosure.

FIG. 14b and FIG. 14c are schematic diagrams showing phase distribution when beamforming is performed using a reconfigurable intelligent surface according to an embodiment of the present disclosure.

FIG. 15 is a schematic diagram showing performance evaluation results of DOA estimation and beamforming using a reconfigurable intelligent surface according to an embodiment of the present disclosure.

FIG. 16 is a schematic diagram showing angular resolutions that can be estimated by using the conventional MUSIC and a DOA estimation system (S-DNN) each under the conditions of a signal-to-noise ratio of 10 dB and different number of sampling snapshots according to an embodiment of the present disclosure.

FIG. 17 is a schematic diagram showing another DOA estimation system 170 according to an embodiment of the present disclosure.

FIG. 18 is a schematic diagram showing some application scenarios using a DOA estimation system according to an embodiment of the present disclosure.

FIG. 19 is a schematic diagram showing a super-resolution DOA estimation device according to an embodiment of the present disclosure.

FIG. 20a is an entity schematic diagram of a single layer of passive intelligent surface according to an embodiment of the present disclosure.

FIG. 20b is an entity schematic diagram of four layers of passive intelligent surfaces according to an embodiment of the present disclosure.

FIG. 20c is a schematic diagram showing phase modulation values distributed on four layers of passive intelligent surfaces according to an embodiment of the present disclosure.

FIG. 21a and FIG. 21b are schematic diagrams respectively showing a confusion matrix and an energy matrix obtained by a reconfigurable intelligent surface, with an angular resolution of 10°, estimating a pitch angle within [−45°, 55° ] according to an embodiment of the present disclosure.

FIG. 22 is a schematic diagram showing DOA estimation performance of four layers of passive intelligent surfaces with different angular resolutions in a one-dimensional estimation mode and a two-dimensional estimation mode according to an embodiment of the present disclosure.

FIG. 23a is a schematic diagram showing angular responses of four layers of passive intelligent surfaces (passive S-DNN) and an existing lens system (i.e., Lens) to different incident plane wave angles according to an embodiment of the present disclosure.

FIG. 23b is a schematic diagram showing confidence of four layers of passive intelligent surfaces in DOA estimation for a single-signal source in a broadband range from 25 GHz to 30 GHz according to an embodiment of the present disclosure.

FIG. 24a is a schematic diagram showing phase distribution of electromagnetic field of an incident wave with a pitch angle of −2.5° and an azimuth angle of 1° according to an embodiment of the present disclosure.

FIG. 24b, FIG. 24c, and FIG. 24d respectively show three types of electromagnetic field intensity measurement results obtained by using four layers of passive intelligent surfaces according to an embodiment of the present disclosure.

FIG. 24e is a schematic diagram showing energy distribution of electromagnetic field intensity in 10 detection areas on a detection module obtained by using four layers of passive intelligent surfaces according to an embodiment of the present disclosure.

FIG. 25a and FIG. 25b are schematic diagrams respectively showing a confusion matrix and an energy matrix obtained by performing estimation on a single-signal source test sample using four layers of passive intelligent surfaces according to an embodiment of the present disclosure.

FIG. 25c and FIG. 25d are schematic diagrams respectively showing a confusion matrix and an energy matrix obtained by performing estimation on a dual-signal source test sample using four layers of passive intelligent surfaces according to an embodiment of the present disclosure.

### DETAILED DESCRIPTION

Various exemplary embodiments, features, and aspects of the present disclosure will be explained in detail below with reference to the accompanying drawings. In the drawings, the same reference signs denote elements with the same or similar functions. Although various aspects of the embodiments are shown in the drawings, unless otherwise specified, the drawings are not necessarily drawn to scale.

The word “exemplary” used here means “serving as an example, embodiment or illustration”. Any embodiment described here as “exemplary” is not necessarily to be interpreted as superior to or better than other embodiments.

In addition, to better explain the present disclosure, numerous details are given in the following embodiments. It is appreciated by those skilled in the art that the present disclosure can still be implemented without some specific details. In some embodiments, methods, means, elements, and circuits well known to those skilled in the art are not described in detail in order to highlight the gist of the present disclosure.

As mentioned above, the conventional MUSIC algorithm requires a large number of RF electronic circuits for demodulation, sampling, and complex algorithmic processing of multi-channel signals, so this method requires high hardware cost, algorithmic complexity, and massive data sampling, which limits its performance in terms of latency, power consumption, and cost. The current research work on photonic processors has demonstrated the major advantages of photonic processors in computing speed, computing throughput, and energy efficiency. By encoding RF signals in the optical domain and using photons for computation, the photonic processor enables filtering, time integration and differentiation, and blind source separation with wider bandwidth. In order to directly process RF signals, diffractive neural network and surface plasmon neural network are constructed to modulate electromagnetic waves and process the information they carry to fulfill different tasks such as object recognition and wireless codecs. Compared with the surface plasmon, the metasurface structure in the diffractive neural network can modulate three-dimensional electromagnetic waves, which makes the diffractive neural network more scalable for large-scale spatial calculation. However, the resolution of the existing diffractive neural network system is still limited by the diffraction limit, and its application in advanced wireless sensing tasks has not been explored. In addition, the application of reconfigurable intelligent surfaces (RIS) to modulation of space electromagnetic waves and building of the next-generation communication system still lacks the capabilities of perception and computation. Therefore, the reconfigurable intelligent surface needs to communicate with the base station to receive the control signal and the user's angular direction, which makes it more challenging to provide low-latency communication services for high-speed rails and autonomous driving.

To meet these challenges, an embodiment of the present disclosure provides a DOA estimation system for all-optical DOA estimation in a broadband frequency range, with an angular resolution exceeding the diffraction limit. There is also provided a super-resolution DOA estimation device, which selectively estimates directions of multiple signal sources over a wide field of view by spatially or temporally multiplexing different DOA estimation systems. Briefly, the DOA estimation system can estimate the pitch angle and the azimuth angle of a signal source by performing DOA estimation in either a one-dimensional estimation mode or a two-dimensional estimation mode, respectively, and robustly classify the input electromagnetic waves from different signal sources into different angle intervals. In order to improve the classification accuracy of the system at angle interval boundaries, for the case of a single signal source, the embodiment of the present disclosure further provides a flexible decision boundary strategy to determine the DOA of the signal source by comparing the two greatest intensity measurement values. Moreover, a multiple-signal source training dataset is used to optimize the relevant parameters of the diffraction modulation module in the DOA estimation system, so as to improve the system's capability to effectively estimate the angles of multiple signal sources. Further, the DOA estimation system provided by the embodiment of the present disclosure has a high-degree-of-freedom design space for large-scale diffraction modulation, which enables the diffraction modulation module in the DOA estimation system to generate a super-oscillation angular response in different local angle ranges, thereby realizing super-resolution DOA estimation beyond the diffraction limit. Further, the embodiment of the present disclosure further provides a super-resolution DOA estimation device, which can fulfill the wide-field-of-view and high-resolution DOA estimation task from coarse to fine by utilizing the diffraction super-resolution characteristics and the spatial or temporal multiplexing function of the DOA estimation system.

In order to facilitate understanding of the DOA estimation system according to the embodiment of the present disclosure, the basic principle of DOA estimation proposed in the embodiment of the present disclosure is first introduced. Specifically, the basic principle of DOA estimation proposed in the embodiment of the present disclosure is to divide the phase distribution of electromagnetic fields of incident waves (that is, incident electromagnetic waves, incident plane waves, etc.) generated by different signal sources (that is, target sources) into different angle intervals; in other words, to take the phase distribution of electromagnetic field of the incident waves generated by the signal sources in a far-field plane as an input to identify angle intervals to which the signal sources belong, and then, based on the angle intervals to which the signal sources belong, determine DOAs corresponding to the signal sources. The DOA may comprise a pitch angle and/or an azimuth angle, and the estimation of the pitch angle and/or the azimuth angle may be realized by using the DOA estimation system according to the embodiment of the present disclosure.

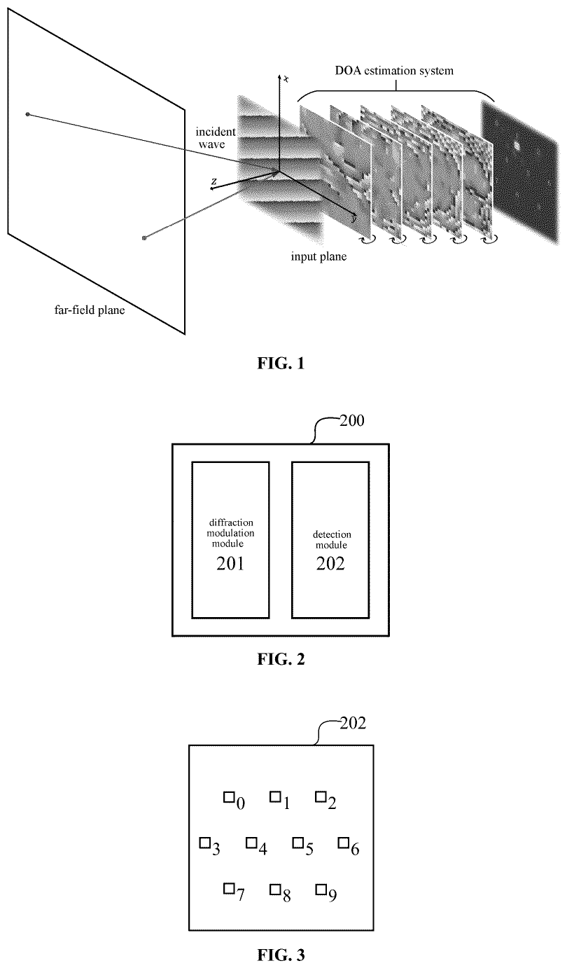

By way of example, taking a center of an input plane of the DOA estimation system (that is, a plane of the system into which the incident wave is incident, which is only a schematic plane) shown in FIG. 1 as the origin of coordinates, on the far-field plane in a z-axis direction, the phase distribution of electromagnetic field of the incident wave generated by any signal source with a pitch angle θ and an azimuth angle φ may be approximated as a far-field plane wave E(x, y, λ) shown in Formula (1):

$$E ( x , y , λ ) = {A}^{′} exp \{ jk ( x sin θ + y cos θ sin ϕ ) \} + {n}_{n o i s e} \qquad ( 1 )$$

where A′=Aexp(jkz₀ cos θ cos φ) is a complex-valued constant, A represents amplitude of the incident wave, k=2π/λ represents vacuum wavenumber, λ∈[λ₁, λ₂]represents an operating wavelength of the incident wave, [λ₁, λ₂] represents a wavelength range that may be estimated by the system, nₙₒᵢₛₑ is a spatially randomized Gaussian noise, j represents an imaginary number, x and y represent horizontal and vertical coordinates of any position on the far-field plane, and z₀ represents a far-field distance between the far-field plane and the input plane, wherein the far-field distance may be set to be greater than the Rayleigh distance to generate a planar optical wavefront. As is clear from the above Formula (1), different signal sources have different pitch angles and azimuth angles, and also have different phase distribution of electromagnetic fields generated on the input plane of the DOA estimation system. Therefore, this characteristic can be utilized to estimate the DOAs of the signal sources by dividing the phase distribution of the electromagnetic fields of the incident waves generated by the different signal sources into different angle intervals, so that low-latency, low-power, and low-cost DOA estimation can be achieved without the need for complex algorithmic processing and high-cost hardware composition.

Based on the basic principle of DOA estimation proposed by the embodiment of the present disclosure, the DOA estimation system provided by the embodiment of the present disclosure will be described in detail below.

FIG. 2 is a schematic diagram showing a DOA estimation system 200 according to an embodiment of the present disclosure. As shown in FIG. 2, the system 200 comprises:
a diffraction modulation module 201 configured to modulate phase distribution of electromagnetic fields of incident waves emitted by N signal sources so as to focus the incident waves on a detection module 202, wherein N≥1 and DOAs corresponding to the signal sources are within a preset angle range,
wherein the detection module 202 comprises a plurality of detection areas, the preset angle range comprises a plurality of angle intervals, and each detection area corresponds to an angle interval; and the detection module 202 configured to measure an intensity of an electromagnetic field in each detection area in the case where the incident waves are focused on the detection module 202 to obtain an intensity measurement value of the electromagnetic field in each detection area, and determine the DOAs corresponding to the N signal sources based on the angle intervals corresponding to the N detection areas with the greatest intensity measurement values.

The preset angle range may be interpreted as the maximum angle range that can be estimated by the DOA estimation system, and the preset angle range may be divided into a plurality of angle intervals based on certain angular resolutions, wherein the angular resolution represents the magnitude of the angle interval; the number of the angle intervals is the same as the number of the detection areas; and K detection areas may be designated on the detection module 202, with each detection area corresponding to an angle interval, so that correct classification of incident waves may be achieved by the plurality of detection areas measuring the intensity of the electromagnetic field. It is appreciated that a person skilled in the art may determine the number of the detection areas in the detection module 202 based on the actual needs, such as the 10 detection areas numbered 0-9 included in the detection module 202 as shown in FIG. 3, and the embodiments of the present disclosure do not impose any limitation on the number of the detection areas in the detection module 202.

For example, if the preset angle range is set to [−45°, 55° ] and the detection module 202 includes 10 detection areas, the [−45°, 55° ] may be divided into 10 angle intervals, i.e., “[−45° 35°], [−35°, −25°], [−25°, −15°], . . . , [25°, 35°][35°, 45° ] and [45°, 55°]”, based on an angular resolution of 10°, so that each detection area corresponds to an angle interval. For example, the detection area numbered 0 in FIG. 3 corresponds to the angle interval of [−45°, −35° ], the detection area numbered 1 corresponds to the angle interval of [−35°, −25° ], and so on until the detection area numbered 9 corresponds to the angle interval of [45°, 55° ]. It is appreciated that a person skilled in the art may determine a preset angle range that the system can estimate and the number of angle intervals within the preset angle range based on the actual needs, which is not limited by the embodiments of the present disclosure.

Optionally, the angular resolution corresponding to the preset angle range may be smaller than the diffraction limit angle (i.e., 4.37°), that is, the preset angle range may be divided based on an angular resolution that is smaller than the diffraction limit angle, so that super-resolution DOA estimation can be realized. For example, the preset angle range of [−15°, 15° ] may be divided into a plurality of angle intervals based on an angular resolution of 1° or 3°. The embodiments of the present disclosure do not impose any limitation on this.

In practical application, each detection area in the detection module 202 may be provided with a detector which is configured to measure the intensity of the electromagnetic field in the detection area to which the detector belongs. For example, the detector may measure the intensity of the electromagnetic field (i.e., obtaining the intensity measurement value) by performing nonlinear processing on the electromagnetic field (e.g., squaring after performing the Modulo Operation on the electromagnetic field), to facilitate rapid acquisition of the DOA estimation result. The embodiments of the present disclosure do not limit the size of each detection area in the detection module 202, and the size of the detection area may also be related to a central wavelength corresponding to the operating frequency band of the system. By way of example, if the operating frequency band of the diffraction modulation module 201 is set to a 5G millimeter-wave communication frequency band and the central wavelength corresponding to the operating frequency band is λ₀, the size of each detection area may be set to 5λ₀/8*5λ₀/8 to match the size of a waveguide probe in the detector which is configured to detect the intensity of the electromagnetic field.

It is appreciated that in addition to detectors, other electronic elements (such as comparators, operational amplifiers, etc.) and logical circuits may be integrated in the detection module 202 to determine the N detection areas with the greatest intensity measurement values, and determine the DOAs corresponding to the N signal sources based on the angle intervals corresponding to the N detection areas with the greatest intensity measurement values. It should be noted that a person skilled in the art may determine the specific circuit structure of the detection module based on the actual needs, and the embodiments of the present disclosure do not impose restrictions on the specific circuit structure in the detection module, as long as the required functions can be realized.

The above diffraction modulation module 201 may be specifically configured to focus an incident wave into a detection area corresponding to an angle interval to which the DOA of the incident wave belongs. For example, if the DOA of an incident wave emitted by a signal source is 30°, the incident wave is focused into a detection area corresponding to an angle interval of [25°, 35° ](for example, the detection area numbered 7 in FIG. 3) after the diffraction modulation module 201 modulates the phase distribution of the incident wave, at which time the electromagnetic field intensity in the detection area corresponding to the angle interval of [25°, 35° ] is the greatest. Therefore, by measuring the intensity of the electromagnetic field in the detection area to classify the DOA of an unknown signal source into a corresponding angle interval, so that the DOA corresponding to the unknown signal source may be estimated.

It is appreciated that when the system estimates the DOA corresponding to a signal source, the DOA of the signal source may be determined by selecting a detection area with the greatest intensity measurement value. In the case where the system estimates the DOAs of a plurality of signal sources, since the phase distribution of the input electromagnetic field is equivalent to the superposition of a plurality of incident waves with different incident angles, the diffraction modulation module 201 may focus each incident wave into its corresponding detection area. Therefore, the angle intervals corresponding to the N detection areas with the greatest intensity measurement values may be selected to determine the DOAs of the N signal sources. That is, the angle intervals in which the DOAs corresponding to the N signal sources are located may be determined by finding the greatest N intensity measurement values in the detection areas, or finding the top N detection areas with the greatest intensity measurement values in a descending order. Since N represents the number of the signal sources, the value of N should be less than or equal to the total number K of the detection areas. For example, if the number K of the detection areas in the detection module 202 is 10, N may be 1, . . . , 10.

Optionally, the DOAs corresponding to the N signal sources determined by the detection module 202 may include intermediate values of the angle intervals corresponding to the N detection areas with the greatest intensity measurement values, that is, the intermediate values of the angle intervals may be used as the estimated DOAs. For example, if, for a certain signal source, the detection module 202 measures that an angle interval corresponding to a detection area with the greatest intensity measurement value is [35°, 45° ], the DOA corresponding to the signal source may be estimated to be 40°. It is appreciated that the smaller the angular resolution of the angle interval, the more accurate the estimation of the DOA is.

It should be noted that taking the intermediate value of the angle interval as the DOA is one possible implementation provided by the embodiment of the present disclosure. In the light of the embodiments of the present disclosure, a person skilled in the art may also choose the minimum or maximum value of the angle interval as the DOA. As long as the DOA corresponding to the signal source is determined based on the angle interval corresponding to the detection area with the greatest electromagnetic field intensity measurement value, such determination should fall within the protection scope of the embodiments of the present disclosure.

In practical application, the diffraction modulation module 201 may be constructed using an intelligent metasurface material known in the art that has phase modulation capability. For example, the diffraction modulation module 201 may be constructed using a passive intelligent surface or a reconfigurable intelligent surface, wherein the passive intelligent surface or the reconfigurable intelligent surface may use a sub-wavelength diffraction modulation unit (i.e., a superatom) to modulate the phase and amplitude of broadband electromagnetic waves, and generate large-scale interlayer optical interconnections through diffraction, that is, the connection between layers of a multilayer intelligent surface can be realized through diffraction of light. Moreover, constructing the diffraction modulation module 201 by using the above passive intelligent surface or reconfigurable intelligent surface can achieve super-resolution angle estimation in any local angle interval within a large field of view.

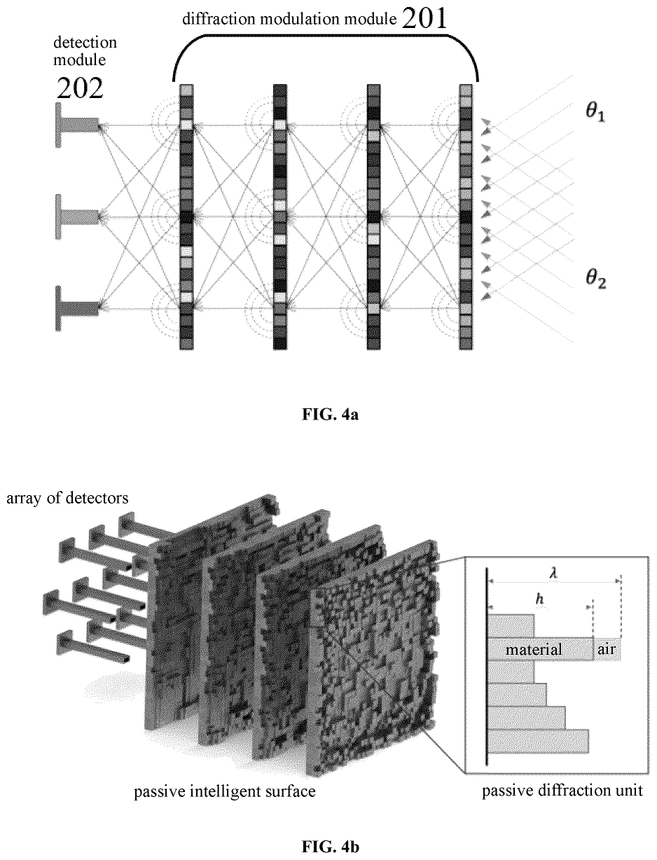

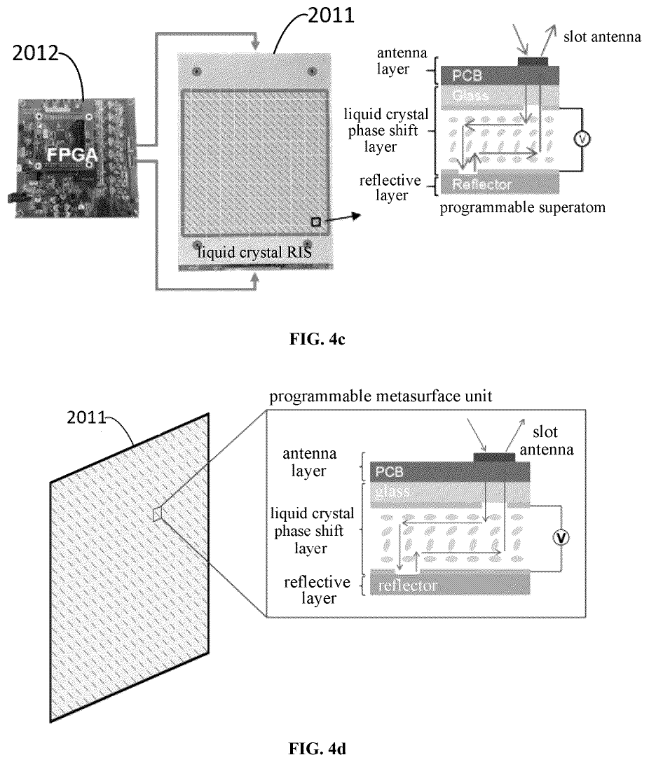

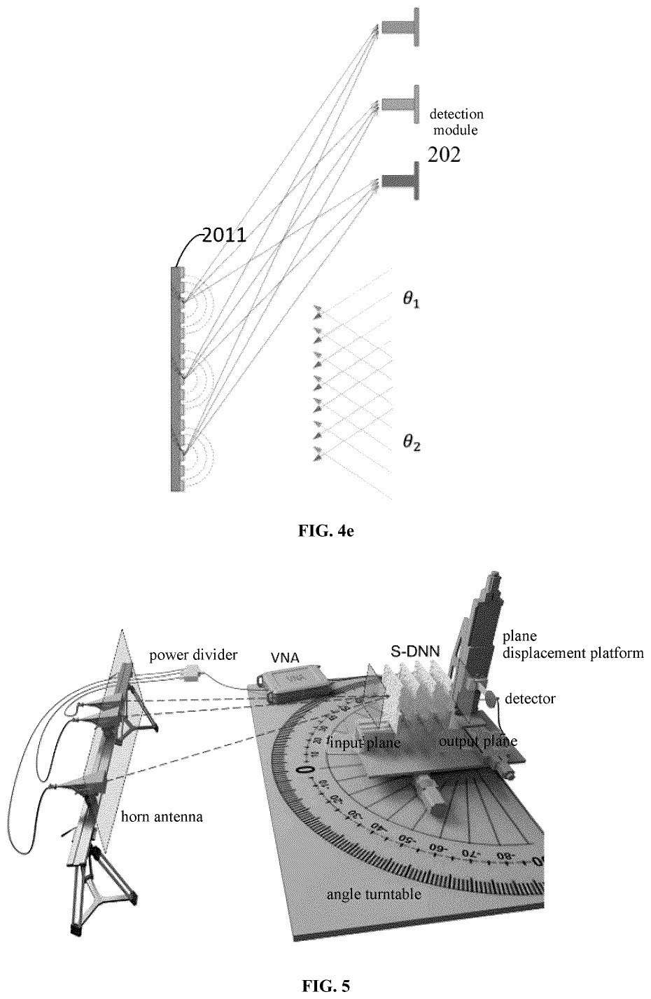

Optionally, the diffraction modulation module 201 may comprise at least one layer of cascaded passive intelligent surface, that is, the diffraction modulation module 201 may be constructed by a single passive intelligent surface or a plurality of passive intelligent surfaces. The diffraction modulation module 201 in a DOA estimation system as shown in FIG. 4a is composed of four layers of cascaded passive intelligent surfaces which are configured to perform phase modulation on incident waves in a transmission mode, that is, incident waves with different DOAs (θ₁ and θ₂) are focused by transmission on the detection module 202, and an array of detectors on the detection module 202 may measure the electromagnetic field intensity in the respective detection area to which the respective detector belongs. As shown in FIG. 4a, since the passive intelligent surface operates in a transmission mode, the detection module 202 may be located on the other side of the incident waves to be able to focus the incident waves on the detection module 202.

In practical application, simulation modeling and analysis software known in the art (such as CST Studio Suite) may be used to perform simulation modeling, analysis, and evaluation on each layer of passive intelligent surface in the diffraction modulation module 201, and then a three-dimensional model of the diffraction modulation module 201 is derived for processing and manufacturing. The passive intelligent surface may be made of a blend of polytetrafluoroethylene F4B (e.g., PTFE-F4B), nano-ceramics, and fiberglass fabric, that is, the passive intelligent surface may be made by mixing polytetrafluoroethylene F4B with homogeneous nano-ceramics and fiberglass fabric. This material has excellent spatial isotropy, and has stable dielectric constant and minimal loss when the electromagnetic wave frequency is lower than 40 GHz. The F4B material may be made by a precision computerized numerical control machine tool to form a passive diffraction unit (hereinafter referred to as a diffraction unit) on the passive intelligent surface. According to a three-dimensional model of four layers of passive intelligent surfaces as shown in FIG. 4b, each layer of passive intelligent surface contains diffraction units of various thicknesses. Assuming that the thickness of the material of the diffraction unit is h and the maximum thickness of the diffraction unit is H, the air thickness is H−h, and the thickness h of the material of each diffraction unit may be adjusted between 0 and H in advance. Considering that the DOA estimation system operates in a wide wavelength range from λ₁ to λ₂, the maximum height H of the diffraction unit may be limited to H=(λ₁+λ₂)/2. The material of the diffraction unit will produce a complex-valued transmission coefficient to allow adjustment of the phase and amplitude of the incident wavefront. By way of example, if interreflection of electromagnetic waves on each diffraction unit is considered and crosstalk between adjacent diffraction units is ignored under smoothing constraints, the complex-valued transmission coefficient t(h, λ) of the diffraction unit may be expressed as Formula (2):

$$\{ \begin{matrix}{t}_{m} ( h , λ ) = \frac{{t}_{12} {t}_{23} exp ( j 2 π nh / λ )}{1 + {r}_{12} {r}_{23} exp ( j 4 π nh / λ )} , \\ {t}_{a} ( H - h , λ ) = exp ( j 2 π ( H - h ) / λ ) , \\ t ( h , λ ) = {t}_{m} ( h , λ ) {t}_{a} ( H - h , λ ) ,\end{matrix} , \qquad ( 2 )$$

where tₘ(h, λ) represents a transmission coefficient of the material of the diffraction unit, tₐ(H−h, λ) represents a transmission coefficient of air, and λ∈[λ₁, λ₂], t₁₂=2/(1+n), t₂₃=2n/(1+n), r₁₂=(1−n)/(1+n), r₂₃=−r₁₂, and n∈[n₁, n₂] represent a relative index of refraction of the material. It can be seen from the above Formula (2) that the thickness of the material of the diffraction unit affects the complex-valued transmission coefficient of the diffraction unit, and different complex-valued transmission coefficients may produce different degrees of phase delay.

Optionally, a diffraction modulation module 201 as shown in FIG. 4c may comprise a reconfigurable intelligent surface 2011 (i.e., a liquid crystal RIS) and a first control unit 2012 (i.e., an FPGA), wherein the first control unit 2012 is configured to apply a modulating voltage to the reconfigurable intelligent surface 2011 to realize phase modulation of the incident wave. As shown in FIG. 4c and FIG. 4d, the reconfigurable intelligent surface 2011 consists of programmable superatoms (i.e., programmable metasurface units), and each programmable metasurface unit comprises an antenna layer, a liquid crystal phase shift layer, and a reflective layer to realize efficient phase modulation of electromagnetic waves, wherein the antenna layer comprises a slot antenna located on a PCB circuit board and configured to receive and send electromagnetic waves; the liquid crystal phase shift layer comprises a glass layer and a liquid crystal layer, the glass layer being able to isolate the liquid crystal layer from the antenna layer, the liquid crystal layer being configured to modulate the phase of electromagnetic waves; and the reflective layer comprises a reflector for reflecting electromagnetic waves. Since the liquid crystal is an anisotropic material, it can be seen from the following Formula (3) that the magnitude of a voltage V between electrodes of the liquid crystal phase shift layer affects a deflection angle ν of the liquid crystal. Thus, the deflection angle ν of the liquid crystal may be adjusted by controlling the voltage V between the electrodes of the liquid crystal phase shift layer, thereby achieving reconfigurability:

$$\frac{V}{2 {V}_{t h}} = \frac{1}{π} {\int }_{0}^{ϑ} {( \frac{{cos}^{2} α + γ {sin}^{2} α}{{sin}^{2} θ - {sin}^{2} α} )}^{\frac{1}{2}} d α , \qquad ( 3 )$$

where Vₜₕ represents a threshold voltage at which the liquid crystal is deflected, and γ represents an elastic constant of the liquid crystal. Further, the deflection angle ν of the liquid crystal affects an effective dielectric constant n(φ) of the liquid crystal as shown by Formula (4):

$$n ( ϑ ) = {( \frac{{cos}^{2} ϑ}{{n}_{⊥}^{2}} + \frac{{sin}^{2} θ}{{n}_{‖}^{2}} )}^{- \frac{1}{2}} , \qquad ( 4 )$$

where n_{⊥} and n_{∥} represent dielectric constants of the liquid crystal deflected into the horizontal direction and the vertical direction, respectively. Therefore, a phase delay γ(ν, λ) of an incident electromagnetic wave modulated by the liquid crystal phase shift layer may be expressed as Formula (5):

$$γ ( ϑ , λ ) = \frac{2 π}{λ} ( n ( ϑ ) - {n}_{⊥} ) d , \qquad ( 5 )$$

where d represents a thickness of the liquid crystal phase shift layer. The above formulas (3) to (5) show that applying different voltages to the liquid crystal phase shift layer may continuously change the dielectric constant of the liquid crystal, thereby achieving high-precision phase modulation.

As shown in FIG. 4e, the reconfigurable intelligent surface 2011 in the diffraction modulation module 201 is configured to perform phase modulation on incident waves in a reflection mode, that is, the reconfigurable intelligent surface 2011 may perform phase modulation on incident waves with different DOAs (θ₁ and θ₂) and reflect the incident waves. Thus, when the diffraction modulation module 201 uses the reconfigurable intelligent surface 2011 which operates in the reflection mode, the detection module 202 may be located on the same side as the incident waves, and in order to avoid obstruction between the detection module 202 and the incident waves, the detection module 202 may be disposed at a diagonal front rather than a central front of the reconfigurable intelligent surface 2011.

In practical application, the first control unit 2012 may be a computing unit with logic processing capability. For example, the first control unit 2012 may be implemented by an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic components, which is not limited by the embodiments of the present disclosure. The first control unit may separately control the voltage of each programmable metasurface unit on the reconfigurable intelligent surface. For example, if the reconfigurable intelligent surface contains 20×20 effective programmable metasurface units, the FPGA may be used to program a 400-channel modulation voltage to modulate the voltage of each of the 20×20 programmable metasurface units.

As mentioned above, the operating frequency band of the diffraction modulation module 201 may be a 5G millimeter-wave communication frequency band, and the central wavelength corresponding to the operating frequency band is λ₀. The design details of the diffraction modulation module 201 for use in a 5G millimeter-wave communication frequency band provided by the embodiment of the present disclosure are as follows. When a passive intelligent surface is employed, the range of the operating frequency of the passive intelligent surface may be set between 25 GHz and 30 GHz, and when a reconfigurable intelligent surface is employed, the range of the operating frequency of the reconfigurable intelligent surface may be set between 25 GHz and 27.5 GHz. For the passive intelligent surface, since the central operating frequency is 27.5 GHz, which corresponds to the central wavelength λ₀=10.9 mm, the size of the diffraction unit of the passive intelligent surface may be set to 5.45 mm. Moreover, since the axial machining accuracy of numerical control machine tools is about 0.1 mm, the phase modulation bit depth of the passive intelligent surface may be about 7 bits. When constructing a reconfigurable intelligent surface, a reflective millimeter-wave liquid crystal RIS may be used. The panel of the reconfigurable intelligent surface may contain 20×20 modulation units (i.e., programmable metasurface units). Each modulation unit may have a phase modulation accuracy of 5 bits and a size of 5.5 mm. In order to improve the accuracy of the numerical model, the number of units (modulation units or diffraction units) in each layer of the intelligent surface in the diffraction modulation module 201 may be set to A×A, the unit size to B×B, the grid size to B/4×B/4, and the number of grids to 4A×4A. For example, A=32 and B=λ₀/2 may be set for a passive intelligent surface, with a corresponding metasurface aperture size being D=16λ₀. Furthermore, the thickness of the substrate of each passive intelligent surface may be 3 mm, and a frame with a width of 50 mm may be added around the substrate for ease of support and alignment, so the diffraction modulation module 201 consisting of the passive intelligent surfaces may have a size of 274.54 mm×274.54 mm. The distance between adjacent layers of passive intelligent surfaces in the diffraction modulation module 201 and the distance between the last layer of passive intelligent surface and the detection module 202 may be set to 5λ₀, which realizes the diffraction modulation module 201 under the fully connected neural network structure.

In practical application, unit parameters of the diffraction modulation module 201 that meet the actual needs may be obtained by performing forward modeling on the diffraction modulation module 201 and optimizing the unit parameters (such as the thickness of the material of the diffraction unit on the passive intelligent surface and the control voltage of the modulation unit on the reconfigurable intelligent surface), and then the solid diffraction modulation module 201 may be manufactured based on the unit parameters optimized by modeling. Through accurate forward modeling, the unit parameters (thickness of material or modulation voltage) of each unit may be optimized during parameter optimization. After the parameter optimization is completed, the diffraction modulation module 201 manufactured by using the optimized unit parameters is able to focus the energy of the incident wave to the detection area corresponding to the incident angle (i.e., DOA).

In practical application, in order to narrow the parameter search space in the parameter optimization stage and to reduce the variation of adjacent units in the prepared diffraction modulation module 201, an activation function (e.g., Sigmoid function) may be applied respectively to the passive intelligent surface and the reconfigurable intelligent surface to limit the thickness of material to 0˜H and limit the range of phase modulation to 0˜2π.

In practical application, a person skilled in the art may employ simulation modeling optimization techniques known in the art to realize forward model and parameter optimization of the diffraction modulation module 201. By way of example, based on the angular spectrum diffraction theory and the Pytorch programming language, modeling of complex-valued transmission coefficient of the diffraction unit on the passive intelligent surface or modeling of the liquid crystal deflection angle of the modulation unit on the reconfigurable intelligent surface may be realized to obtain a simulation digital model corresponding to the diffraction modulation module 201, and modeling of free-space optical field propagation in a broadband wavelength range may also be realized, that is, simulation modeling of incident waves at different angles can be realized. Specifically, simulation modeling of broadband free-space optical field propagation may be performed using Rayleigh-Sommerfeld diffraction implemented by the angular spectrum approach (ASM), and zero padding may be added to the periphery of the simulation digital model to ensure the boundary conditions of the simulation digital model. The output of the simulation digital model measures the electromagnetic field intensity of the simulated incident wave by means of a simulation detector to obtain a predicted DOA, compares the predicted DOA with a real label of the simulated incident wave (e.g., the real DOA of the incident wave), and uses a predefined loss function to calculate a loss between the real DOA and the predicted DOA, and thus model parameters (i.e., thickness of material or modulation voltage) may be optimized in a preset parameter search space by using the loss and the error back propagation method, so as to minimize the loss function to obtain the optimal model parameters.

For example, the mean square error (MSE) loss function may be used for optimization to obtain a more robust diffraction modulation model, and the cross-entropy loss function may be used to prove the potential upper limit of angular resolution of the diffraction modulation model. The learning rate, batch size, and number of training rounds in the parameter optimization phase may for example be set to 0.01, 128, and 100, respectively. The complex-valued transmission coefficient in the above Formula (2) may be interpreted as an approximate model for electromagnetic field modeling to facilitate effective training of the passive intelligent surface. Therefore, for the multilayer passive intelligent surfaces, which are more difficult to optimize, under the guidance of full-wave electromagnetic field simulation results obtained by the CST time-domain finite integration technology, dual adaptive training (DAT) may be further employed to fine-tune the thickness of the material of each diffraction unit, so that the designed simulation digital model of the passive intelligent surfaces is able to adapt to machining errors.

In practical application, the training dataset and the test dataset used to optimize the model parameters may be obtained from far-field plane waves with a pitch angle θ and an azimuth angle p generated by different signal sources, and random initial phase values may be set. Each incident plane wave corresponds to an phase distribution of electromagnetic field, and then the simulation digital model is controlled to learn to use the phase distribution of electromagnetic field to estimate the angle intervals where the signal sources are located. The training dataset and the test dataset in the optimization task may, for example, include at least 10,000 samples, each sample including the real DOA of the incident wave. A spatial random Gaussian noise nₙₒᵢₛₑ may be added to the broadband free-space optical field, and the signal-to-noise ratio may be set to 10 dB during training and testing.

By way of example, if the diffraction modulation module 201 is configured to realize DOA estimation for a preset angle range of ρ∈[−45°, 55° ], i.e., a field-of-view size of 100°, the process of generating the training dataset in the parameter optimization task may include dividing the preset angle range of [−45°, 55°] into ten intervals of {ρᵢ,i=0, . . . , 9}, wherein each of the angle intervals is ρᵢ∈[−45+10i, −35°+10i], and the angle intervals correspond to ten detection areas numbered i (i=0, . . . , 9) of the detection module 201, respectively. For each angle interval of 10°, 1000 training samples may be generated by randomizing the azimuth angle based on the Formula (1), that is, ρᵢⱼ=−45°+10i+(−35°+10i−(−45°+10i))·xⱼ, where xⱼ represents a random value between 0 and 1, and j=1, . . . , 1000. In addition, the pitch angle θ of each incident wave may be set to a random value within the angle range of [−5°, 5° ], which can make the azimuth angle estimation capability of the DOA estimation system robust to pitch angle perturbations (e.g., pitch angle perturbations caused by antenna placement errors).

In practical application, in order to improve the DOA resolution performance of the simulation digital model for multiple signal sources, training samples of the multiple-signal sources may be further generated on the basis of the training samples of the single-signal source. Specifically, the optical field of the training samples of each of the multiple signal sources may be obtained by superimposing the optical field vectors of the training samples of the single-signal source. Test samples in the test dataset may be generated in the same manner. To facilitate model evaluation and experimentation, angles within a range of one-tenth of the boundary of each angle interval are not sampled in the unbounded test dataset. For a complete test dataset containing interval boundary angle sampling, angles within a range of one-tenth of the boundary of each angle interval may be sampled. During the experiment, the experimental equipment shown in FIG. 5 may be employed, for example, to generate test samples. As shown in FIG. 5, the experimental equipment may comprise a vector network analyzer (VNA), a power divider, a horn antenna, an angle turntable, a plane displacement platform, and a detector; and a diffraction modulation module (i.e., S-DNN) may be provided between the input plane and the output plane. During the experiment, source signals generated by the vector network analyzer are connected, through the power divider, to two horn antennas spaced 1° apart to serve as two signal sources to generate electromagnetic waves. By controlling the angle turntable to rotate in a uniform step size within the field of view, test samples with different angles may be generated, and the plane displacement platform may also be controlled to move in the horizontal and vertical directions to generate test samples with different angles.

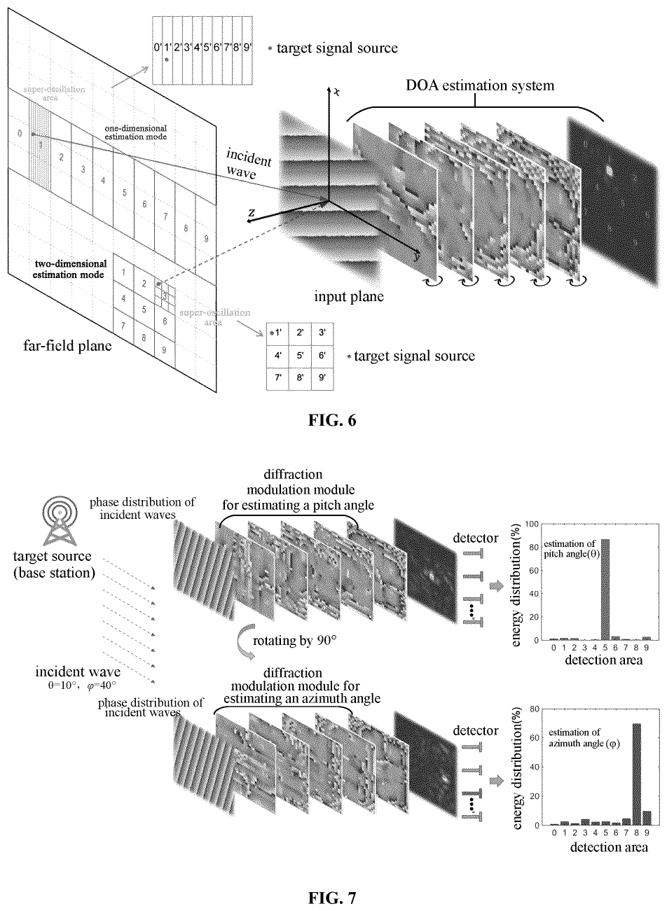

It is appreciated that the same training dataset generation approach and test dataset generation approach may also be employed for other diffraction modulation models with different preset angle ranges and angle interval sizes. For example, in a task of super-resolution DOA estimation of incident waves in a super-oscillation area shown in FIG. 6, ten angle intervals of 1° of the diffraction modulation model with a field of view size of 10° and a preset angle range of ρ′∈[−5°, 5° ] may be expressed as ρᵢ∈[−5°+i, −4°+i], where i=0, . . . , 9. Thus, the training samples and the test samples may be generated as follows: ρᵢ∈=−5°+i+(−4°+i−(−5°+i))·xⱼ.

In practical application, evaluation indexes known in the art may be used to verify the performance of the obtained diffraction modulation model in terms of DOA estimation. For example, angle classification accuracy may be used to indicate model confidence; and the angle evaluated from the root mean square error may be used to estimate the accuracy. When calculating the root mean square error, a central angle value of each angle interval may be set as an estimated DOA. Further, when the performance of DOA estimation of the diffraction modulation model meets a preset standard, the diffraction modulation module may be manufactured based on the diffraction modulation model. The embodiments of the present disclosure do not impose restrictions on the manufacturing process of the diffraction modulation module.

As mentioned above, the DOA includes a pitch angle and/or an azimuth angle. As shown in FIG. 6, the DOA estimation system 200 may estimate the pitch angle and the azimuth angle respectively in the one-dimensional estimation mode, that is, the super-resolution pitch angle or azimuth angle of the target signal source in the super-oscillation area (1′) may be estimated; or the pitch angle and the azimuth angle simultaneously in the two-dimensional estimation mode may be estimated, that is, the super-resolution pitch angle and azimuth angle of the target signal source in the super-oscillation area (1′) may be estimated.

In practical application, in the one-dimensional estimation mode, two sets of the DOA estimation systems 200 may be provided to estimate the pitch angle and the azimuth angle, respectively. In the two-dimensional estimation mode, due to the limited detection areas (e.g., there are 10 detection areas) in the detection module 202, the field of view that can be estimated by the DOA estimation system with the same angular resolution will be greatly reduced. Therefore, the characteristics of the one-dimensional estimation mode may be utilized to realize two-dimensional angle estimation. As can be appreciated, since the pitch angle and the azimuth angle are orthogonal directions in a three-dimensional space, the diffraction modulation module for estimating the pitch angle and the azimuth angle may be exchanged by rotating the diffraction modulation module by 90° as shown in FIG. 7, that is, estimation of the pitch angle and estimation of the azimuth angle may be switched by controlling the diffraction modulation module to rotate by 90°. For the diffraction modulation module composed of the passive intelligent surfaces, the rotation of the diffraction modulation module may be realized by providing a rotating member; and for the diffraction modulation module composed of the reconfigurable intelligent surfaces, the modulation voltage of the liquid crystal phase shift layer may be changed by means of the first control unit to realize the switching between the estimation of the pitch angle and the estimation of the azimuth angle. For example, adjusting the modulation voltage used in estimating the pitch angle to the modulation voltage used in estimating the azimuth angle is equivalent to rotating the diffraction modulation module by 90°. It is appreciated that during the simulation modeling optimization of the diffraction modulation module, two sets of model parameters (thickness of material and modulation voltage) may be respectively determined for the pitch angle and the azimuth angle to facilitate the DOA estimation in the two-dimensional estimation mode.

In practical application, the diffraction modulation module may be optimized first for the pitch angle estimation task, which needs to be robust to the change of the azimuth angle, and this can be achieved by setting a random azimuth angle within a preset angle range of [−50°, 50° ] in the training dataset. Therefore, based on relative angular transformation in the three-dimensional space, the optimized diffraction modulation module for estimating the pitch angle may be rotated by 90° to perform azimuth angle estimation, at which time the diffraction modulation module is also robust to the change of the pitch angle. FIG. 7 shows the process of two-dimensional DOA estimation for the pitch and azimuth angles using the optimized diffraction modulation module, with a two-dimensional preset angle range between −45° and 55° and an angle interval size of 10°. For an incident wave emitted by a target source (base station) with a pitch angle θ of 10° and an azimuth angle φ of 40°, the maximum energy (i.e., the maximum electromagnetic field intensity) can be measured in a detection area numbered 5 (corresponding to an angle interval of [5°, 15° ]) on the detection module 202. The diffraction modulation module is then rotated by 90° to perform azimuth angle estimation, at which point the maximum energy (i.e., the maximum electromagnetic field intensity) can be measured in a detection area numbered 8 (corresponding to an angle interval of [35°, 45° ]). It can be seen that the two-dimensional estimation mode has high accuracy. Experimental results show that the angle classification accuracy of the two-dimensional estimation mode on 10,000 test samples may reach 97.6%, which proves the effectiveness of the two-dimensional DOA estimation mode in the embodiment of the present disclosure.

According to the DOA estimation system provided by the embodiment of the present disclosure, the phase distribution of the electromagnetic fields of the incident waves is modulated by the diffraction modulation module 201 to focus the incident waves on the detection module 202, then the electromagnetic field intensity in each detection area is measured by the detection module 202, and the DOAs of the N signal sources are determined directly based on the angle intervals corresponding to the largest N detection areas. Compared with the prior art, the DOA estimation system of the present disclosure is able to achieve low-latency, low-power, and low-cost DOA estimation without the need for high-cost hardware components, complex algorithmic processing, and massive data sampling.

The DOA estimation system according to the embodiment of the present disclosure has all-optical edge computing and broadband angle perception capabilities, and may be applied to a millimeter-wave communication system to realize low-latency Integrated Sensing and Communication. With the support of the passive intelligent surface and the reconfigurable intelligent surface, the DOA estimation system is able to autonomously perceive the electromagnetic environment independently of the base station, which is conducive to the realization of real-time communication links between the base station and a high-speed mobile user terminal.

In practical application, after estimating the DOA corresponding to the signal source, i.e., after estimating the DOA of the incident wave, the incident wave of the signal source may usually be beamformed based on the DOA of the signal source to enhance communication signal transmission. Thus, according to one possible implementation, in the case where the diffraction modulation module 201 comprises at least one layer of cascaded passive intelligent surface, the system further comprises:
a beamforming module 203, comprising: a reconfigurable intelligent surface and a second control unit, wherein the reconfigurable intelligent surface in the beamforming module 203 is configured to beamform an incident wave; and
the second control unit is configured to determine a control voltage required for beamforming incident waves emitted by N signal sources based on DOAs corresponding to the N signal sources and a direction angle of a signal receiver, and apply the control voltage to the reconfigurable intelligent surface in the beamforming module 203, so that the reconfigurable intelligent surface in the beamforming module 203 is able to beamform the incident waves and reflect the beamformed incident waves to the signal receiver.

The reconfigurable intelligent surface in the beamforming module 203 may have the same material structure as the reconfigurable intelligent surface in the diffraction modulation module. For example, the reconfigurable intelligent surface in the beamforming module 203 may include 20×20 modulation units, wherein the size of each modulation unit may be 5.5 mm×5.5 mm for example; each modulation unit may comprise an antenna layer, a liquid crystal phase shift layer, and a reflective layer; and the phase modulation accuracy of the reconfigurable intelligent surface is 5 bits, which needs to be controlled by a 400-channel control voltage. The dielectric constant of the liquid crystal phase shift layer may be changed by means of the control voltage applied to the modulation unit to realize the phase modulation of the incident electromagnetic wave. The beamforming module uses the reflective liquid crystal phase shift layer to modulate the phase of the incident electromagnetic field to realize beamforming communication, that is, the reconfigurable intelligent surface in the beamforming module 203 uses its phase modulation capability to realize the beamforming of the incident wave. It is appreciated that the embodiments of the present disclosure do not impose restrictions on the specific implementations of beamforming.

In practical application, the signal source may include, for example, a user terminal (e.g., a mobile terminal or a vehicular terminal), and the signal receiver may be, for example, a base station, of which the direction angle (including a pitch angle and an azimuth angle) is normally known. Therefore, after the DOA of the signal source is estimated, a phase value required for optimizing the beamforming of the incident wave may be determined based on the DOAs corresponding to the N signal sources and the direction angle of the signal receiver, and then the phase value required for optimizing the beamforming may be converted into a control voltage. For example, for a reconfigurable intelligent surface consisting of 20×20 modulation units, the phase value may be converted to a 400-channel voltage value, and then the control voltage of each modulation unit on the reconfigurable intelligent surface in the beamforming module may be set based on the converted control voltage. That is, a control voltage is applied to the reconfigurable intelligent surface in the beamforming module, so that the reconfigurable intelligent surface in the beamforming module is able to beamform the incident wave and reflect the beamformed incident wave to the signal receiver. It is appreciated that the DOA or DOAs corresponding to one or more signal sources may be estimated by using the above diffraction modulation module and the detection module, so the incident waves emitted by a plurality of signal sources may be beamformed and reflected to the base station based on the known direction angle of the base station.

In practical application, the second control unit may be a computing unit with logic processing capability. For example, the second control unit may be implemented by an application specific integrated circuit (ASIC), a digital signal processor (DSP), a digital signal processing device (DSPD), a programmable logic device (PLD), a field programmable gate array (FPGA), a controller, a microcontroller, a microprocessor, or other electronic components, which is not limited by the embodiments of the present disclosure. The second control unit may separately control the voltage of each modulation unit (programmable metasurface unit) on the reconfigurable intelligent surface. For example, if the reconfigurable intelligent surface contains 20×20 effective modulation units, the FPGA may be used to program a 400-channel modulation voltage to control the voltage of each of the 20×20 modulation units.

As mentioned above, the diffraction modulation module 201 may also comprise a reconfigurable intelligent surface and a first control unit. Thus, according to one possible implementation, in the case where the diffraction modulation module 201 comprises a reconfigurable intelligent surface and a first control unit, the first control unit is further configured to:
determine, based on DOAs corresponding to N signal sources and a direction angle corresponding to a signal receiver, a control voltage required for beamforming incident waves emitted by the N signal sources, and apply a control voltage to the reconfigurable intelligent surface in the diffraction modulation module 201, so that the reconfigurable intelligent surface in the diffraction modulation module 201 beamforms the incident waves and reflects the beamformed incident waves to the signal receiver. This approach may be understood as that when the diffraction modulation module 201 is composed of the reconfigurable intelligent surface and the first control unit, the diffraction modulation module 201 may be directly multiplexed to execute the beamforming function.

Referring to the above implementation in which beamforming is realized using the beamforming module, the first control unit and the reconfigurable intelligent surface in the diffraction modulation module 201 may be used to realize beamforming. It is appreciated that the first control unit may change the phase modulation capability of the reconfigurable intelligent surface by changing the control voltage applied to the reconfigurable intelligent surface, so that the diffraction modulation module may execute not only the DOA estimation function, but also the beamforming function.

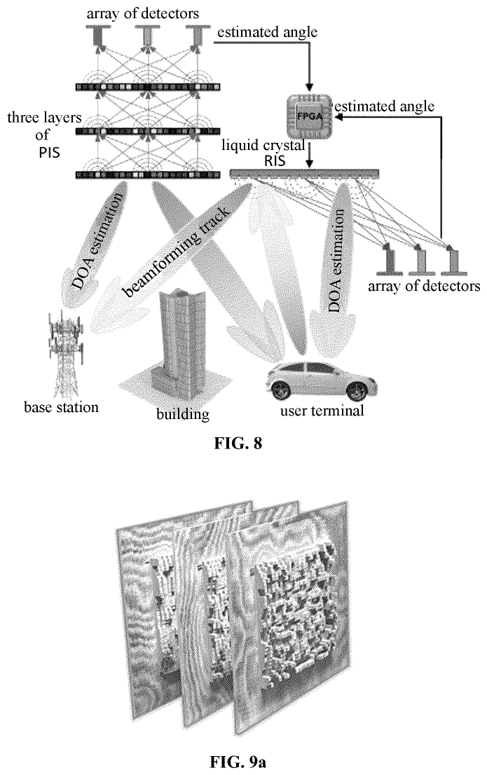

By way of example, FIG. 8 shows an application scenario in which the all-optical edge computing capability of the passive intelligent surface or the reconfigurable intelligent surface is applied to a communication system. As shown in FIG. 8, DOA estimation may be performed on the base station and the user terminal by using three layers of passive intelligent surfaces (i.e., three layers of PIS, which constitute the diffraction modulation module) and an array of detectors (i.e., the detection module), the estimated angles (including the direction angle of the base station and the DOA of the user terminal) are sent to the FPGA, the FPGA may determine a control voltage based on the direction angle of the base station and the DOA of the user terminal and set each modulation unit of the reconfigurable intelligent surface (i.e., the liquid crystal RIS), and the reconfigurable intelligent surface may beamform the incident wave emitted by the user terminal and reflect it to the base station to realize beamforming tracking. With the passive intelligent surfaces and the array of detectors, all-optical DOA estimation of multiple signal sources may be performed with extremely low latency, the latency time depending on the detection speed, and the FPGA may optimize the beamforming phase and set the control voltage of the reconfigurable intelligent surface based on the DOA estimation results of the base station and the user terminal to reflect the electromagnetic wave emitted by the base station to the user terminal to realize beamforming tracking. Alternatively, the reconfigurable intelligent surface and the array of detectors may be used to perform DOA estimation on the user terminal, the estimated DOA of the user terminal may be sent to the FPGA, and the FPGA may determine a control voltage based on the DOA of the user terminal estimated by the reconfigurable intelligent surface and the array of detectors as well as the known direction angle of the base station, and configure each modulation unit of the reconfigurable intelligent surface to beamform the incident wave sent by the user terminal and reflect it to the base station.

In practical application, in order to improve the confidence of the passive intelligent surface in a DOA estimation task of multiple-signal sources, three layers of passive intelligent surfaces may be designed and constructed to carry out super-resolution DOA estimation with 3° angular resolution within a preset angle range of [−15°, 15° ]. By way of example, FIG. 9a shows a solid configuration of three layers of passive intelligent surfaces. The embodiment of the present disclosure evaluates the performance of the three layers of passive intelligent surfaces shown in FIG. 9a on different dual-signal source test datasets (including incident electromagnetic waves superimposed by multiple sets of dual-signal sources), to obtain a confusion matrix acquired by the three layers of passive intelligent surfaces being experimented on all permutations and combinations of the DOAs of the dual-signal sources as shown in FIG. 9b. The abscissa of the confusion matrix represents angle intervals to which the DOAs of the signal sources actually belong, and the ordinate represents detection areas detected by using the three layers of passive intelligent surfaces, wherein the angle interval and the detection area, which have the same number, correspond to each other. As shown in FIG. 9b, all permutations and combinations of the DOAs of the dual-signal sources include permutations and combinations in which the DOAs corresponding to the dual signal sources are respectively in adjacent angle intervals (e.g., 0&1 represents two adjacent angle intervals 0 and 1), the DOAs corresponding to the dual-signal sources are spaced apart by one angle interval (e.g., 0&2 represents angle intervals 0 and 2 spaced apart by one angle interval), and the DOAs corresponding to the dual-signal sources are spaced apart by any angle intervals (e.g., 0&3 represents angle intervals 0 and 3 spaced apart by two angle intervals), and so on in a similar fashion. The numerical values in the confusion matrix represent the number of samples in the test dataset (one sample is a signal source) that are classified into respective detection areas. For example, when the test dataset contains 400 samples located in the angle intervals of 0 and 1 respectively, 199 samples are classified into the detection area 0, 198 samples are classified into the detection area 1, and 1 sample is classified into the detection area 2; and if the test dataset contains 400 samples located in the angle intervals of 0 and 9 respectively, 199 samples are classified into the detection area 0, 200 samples are classified into the detection area 9, and 1 sample is classified into the detection area 1, and so on in a similar fashion. It can be seen that the three layers of passive intelligent surfaces may be utilized to achieve at least 95.7%, 99.5% and 94.9% confidence when the dual-signal sources in the test dataset are in adjacent angle intervals, in angle intervals space apart by one angle interval, and in angle intervals space apart by any angle intervals, respectively. If the RMSE index is used to evaluate the angle estimation accuracy, the estimation accuracy of 0.81°, 0.77°, and 0.88° may be achieved, respectively, and the average energy percentage of correct angle classification may reach 40.6%, 34.9% and 33.7%, respectively.

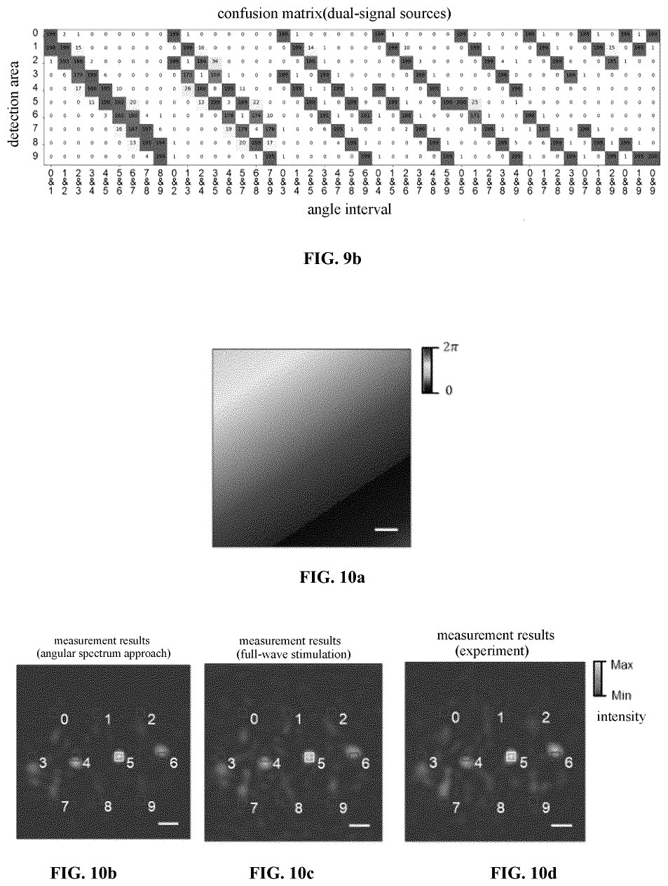

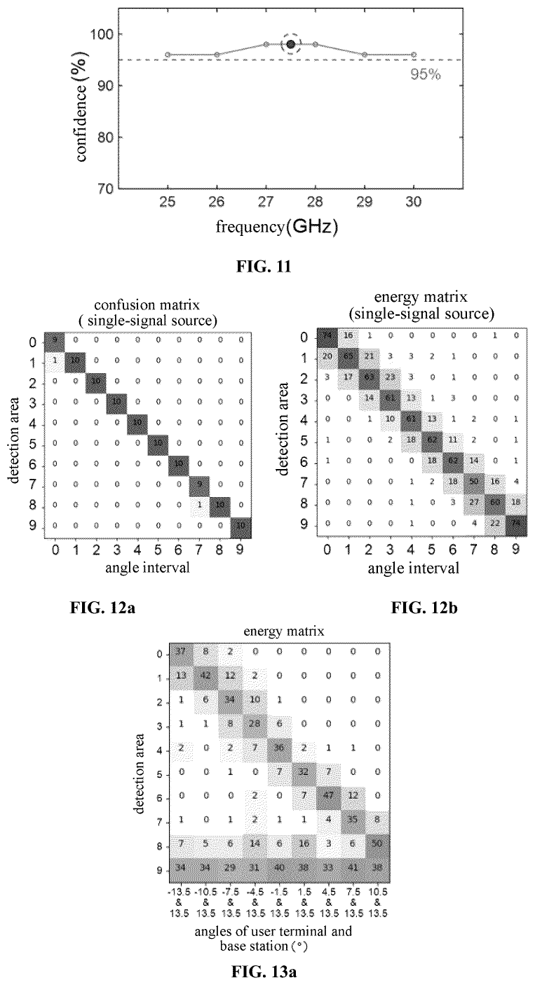

For the phase distribution of the incident electromagnetic waves shown in FIG. 10a, the embodiment of the present disclosure further provides three electromagnetic field intensity measurement results as shown in FIG. 10b, FIG. 10c, and FIG. 10d. FIG. 10b shows intensity measurement results of electromagnetic fields in 10 detection areas obtained using the angular spectrum method, FIG. 10c shows intensity measurement results of electromagnetic fields in 10 detection areas obtained using the full-wave simulation method, and FIG. 10d shows intensity measurement results of electromagnetic fields in 10 detection areas obtained by conducting a solid experiment using the three layers of passive intelligent surfaces shown in FIG. 9a. As can be seen from FIG. 10b, FIG. 10c, and FIG. 10d, for the same phase distribution, the measurement results during the two simulation modeling have high similarity with the measurement results output by the solid experiment, that is the intensity measurement value in the detection area numbered 5 is the greatest in both cases, which demonstrates the robustness of the three layers of passive intelligent surfaces proposed in embodiment of the present disclosure, and demonstrates the three layers of passive intelligent surfaces' correct estimation of the DOA of a single signal source with a pitch angle of 1.5° and an azimuth angle of 1°, that is, the detection area corresponding to the pitch angle interval of [0°, 3°] has the maximum electromagnetic field intensity. FIG. 11 shows the DOA estimation performance of the three layers of passive intelligent surfaces in a broadband DOA estimation task with incident wave frequencies from 25 GHz to 30 GHz. It can be seen from FIG. 11 that the confidence of the three layers of passive intelligent surfaces in the broadband DOA estimation task with incident wave frequencies from 25 GHz to 30 GHz is higher than 95%, that is, the broadband DOA estimation using the three layers of passive intelligent surfaces has high confidence.

FIG. 12a and FIG. 12b respectively show a confusion matrix and an energy matrix obtained from experiments on a test dataset of 100 single-signal sources using the three layers of passive intelligent surfaces, wherein the single-signal source may have a center frequency of 27.5 GHz. The abscissa of the confusion matrix shown in FIG. 12a represents angle intervals to which the DOAs of the signal sources actually belong, the ordinate represents the detection areas estimated using the three layers of passive intelligent surfaces, and the numerical values in the confusion matrix represent the number of the signal sources in the test dataset classified into respective detection areas. For example, for 10 signal sources of which the DOAs are located in the angle interval of 0, 9 signal sources are classified into the detection area 0, and 1 signal source is classified into the detection area 1; and for 10 signal sources of which the DOAs are located in the angle interval of 1, the 10 signal sources are all classified into the detection area 1, and so on in a similar fashion. The abscissa of the energy matrix shown in FIG. 12b represents the angle intervals to which the DOAs of the signal sources actually belong, the ordinate represents the detection areas estimated by using the three layers of passive intelligent surfaces, and the numerical values in the energy matrix represent the electromagnetic field intensity of each signal source in each detection area measured by using the three layers of passive intelligent surfaces. For example, for a signal source of which the DOA is located in the angle interval of 0, the energy percentage in the detection area 0 is measured to be 74, the energy percentage in the detection area 1 is measured to be 20, the energy percentage in the detection area 2 is measured to be 3, and so on in a similar fashion, wherein the energy percentage refers to the percentage of the energy of a detection area to the sum of the energy of the ten detection areas. As can be seen from FIG. 12a and FIG. 12b, the three layers of passive intelligent surfaces according to the embodiment of the present disclosure may also have high confidence, high estimation accuracy, and high average energy percentage of correct angle classification when estimating the DOA of a single-signal source.

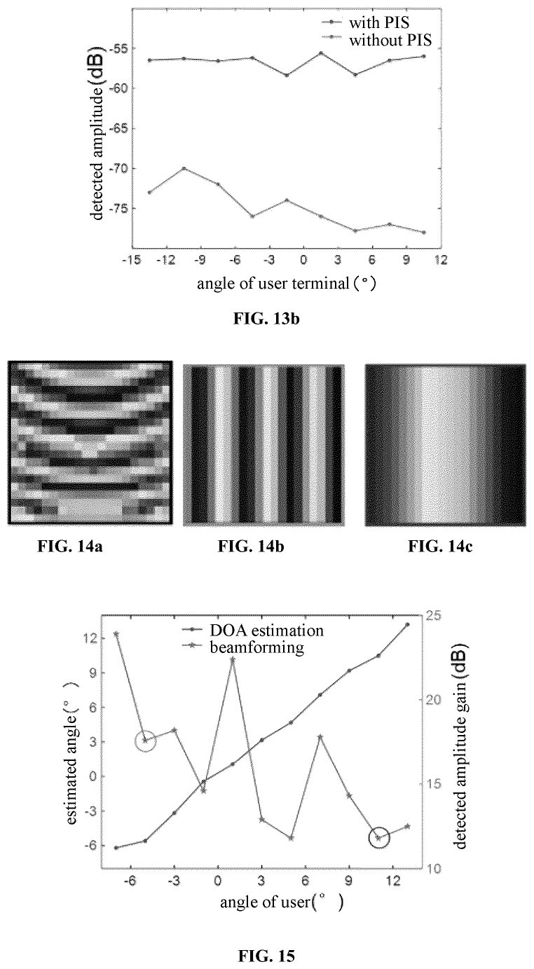

During the experiment, the two horn antennas shown in FIG. 5 may be used to represent the base station and the user terminal, respectively. The incident angle of the base station may be fixed at 13.5°, and the angle of the user terminal may be changed from −13.5° to 10.5° in a step size of 3°. Thus, an energy matrix when the three layers of passive intelligent surfaces are used to perform synchronous DOA estimation on the base station and the user terminal shown in FIG. 13a may be obtained, wherein the abscissa represents the respective actual angles of the user terminal and the base station, the ordinate represents the detection areas into which the user terminal and the base station are divided and which are estimated by using the three layers of passive intelligent surfaces, and the numerical values in the energy matrix represent the measured energy percentage of each detection area. As can be seen in FIG. 13a, the super-resolution DOA estimation for both the base station and the user terminal may be precisely realized using the three layers of passive intelligent surfaces.

In practical application, based on the DOAs of the user terminal and the base station estimated by using the three layers of passive intelligent surfaces, the reconfigurable intelligent surface may be further used to optimize the beamforming phase and build a communication link between the base station and the user terminal, which is able to achieve an average detection amplitude gain of 17.9 dB. FIG. 13b shows signal amplitudes detected at the antenna of the user terminal using the passive intelligent surface (i.e., with the PIS) and not using the passive intelligent surface (i.e., without the PIS), respectively, when electromagnetic waves of the user terminal at different angles are beamformed. As can be seen from FIG. 13b, the signal amplitude detected is higher when the passive intelligent surface is used. Therefore, for DOA estimation without the passive intelligent surface, the reconfigurable intelligent surface cannot accurately guide the beam, and the antenna of the user terminal can only detect environmental noise.

Based on the programmability and the high modulation accuracy of a single independent reconfigurable intelligent surface, the reconfigurable intelligent surface is able to realize DOA estimation and beamforming based on a time division multiplexing mechanism. For example, when the angle of the base station is known to be −13.5° and the estimated DOAs of the user terminal are −5° and 11°, the phase distribution (i.e., the distribution of the phase modulation values) for performing DOA estimation by using the reconfigurable intelligent surface may be as shown in FIG. 14a, and the phase distribution for beamforming may be as shown in FIG. 14b and FIG. 14c. In order to improve the beamforming capability of the reconfigurable intelligent surface, the embodiment of the present disclosure further evaluates the performance of DOA estimation and beamforming when the user terminal moves within a range of [−7°, 13.5° ], and obtains an evaluation result as shown in FIG. 15. As shown in FIG. 15, the blue broken line represents the output estimated angles (i.e., the estimated DOAs) when DOA estimation is performed on different user angles (i.e., the user terminals with different angles) by using the reconfigurable intelligent surface, and the yellow broken line represents the amplitude gain when beamforming is performed on user terminals with different angles by using the reconfigurable smart surface. As can be seen from FIG. 15, since the accuracy of DOA estimation by using the reconfigurable intelligent surface is high, high-precision angle estimation with an RMSE of 0.44 degrees may be realized; and a higher amplitude gain may be obtained when the reconfigurable intelligent surface is used to perform beamforming. As mentioned above, based on the known angle of the base station and the estimated angle of the user, the reconfigurable intelligent surface optimizes the beamforming phase and converts it to a 400-channel control voltage value to configure the modulation unit of the reconfigurable intelligent surface, and the reconfigurable intelligent surface, after reflecting the electromagnetic wave, is able to achieve an average detection amplitude gain of 16.1 dB at the antenna of the user terminal, that is, the average amplitude gain of beamforming by using the reconfigurable intelligent surface may reach 16.1 dB. In addition, by making use of the advantages of the reconfigurable intelligent surface, the number of signal sources may be estimated, which provides additional prior information for the whole DOA estimation system.

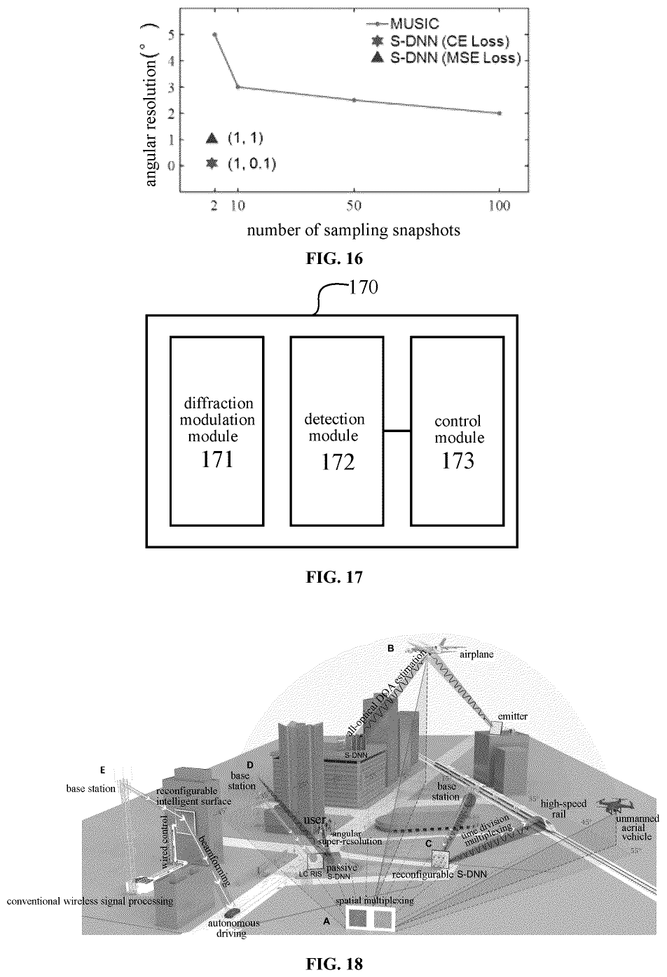

FIG. 16 shows the angular resolutions that can be estimated by using the conventional MUSIC and the DOA estimation system (S-DNN) according to the embodiment of the present disclosure, respectively, under the conditions of a signal-to-noise ratio of 10 dB and different numbers of sampling snapshots. As shown in FIG. 16, in the case of a small number of snapshots and a low signal-to-noise ratio, compared with the conventional MUSIC, the DOA estimation system according to the embodiment of the present disclosure has greater advantages in DOA estimation and has better angular resolution performance. When the array size is the same, the DOA estimation system provided by the embodiment of the present disclosure is able to realize DOA estimation with a higher angular resolution without the need for sampling. Moreover, compared with the conventional MUSIC, the DOA estimation system provided by the embodiment of the present disclosure is more robust to input noise, thereby facilitating low-latency communication based on the reconfigurable intelligent surface.

FIG. 17 is a schematic diagram of another DOA estimation system 170 according to an embodiment of the present disclosure. As shown in FIG. 17, the system 170 comprises:
a diffraction modulation module 171 configured to modulate phase distribution of electromagnetic fields of incident waves emitted by N signal sources to focus the incident waves on a detection module 172, wherein N≥1;
the detection module 172 comprising a plurality of detection areas and being configured to measure an intensity of an electromagnetic field in each detection area in the case where the incident waves are focused on the detection module to obtain an intensity measurement value of the electromagnetic field in each detection area, and send the intensity measurement value of the electromagnetic field in each detection area to a control module 173; and
the control module 173 configured to determine DOAs corresponding to the N signal sources based on the intensity measurement value of the electromagnetic field in each detection area sent by the detection module.

The diffraction modulation module 171 may comprise at least one layer of cascaded passive intelligent surface which is configured to perform phase modulation on the incident waves in a transmission mode and which is made by mixing polytetrafluoroethylene, nano-ceramics, and fiberglass fabric. Alternatively, the diffraction modulation module 172 may comprise a reconfigurable intelligent surface, the reconfigurable intelligent surface in the diffraction modulation module being configured to perform phase modulation on the incident waves in a reflection mode. The structural composition, modeling, and preparation method of the passive intelligent surface and the reconfigurable intelligent surface in the diffraction modulation module 171 according to the embodiment of the present disclosure may refer to the diffraction modulation module 201 in FIG. 2, and will not be repeated herein.

It is appreciated that when the reconfigurable intelligent surface is included in the diffraction modulation module 171, the control module 173 according to the embodiment of the present disclosure may function as the first control unit, that is, the control module 173 may be configured to apply a modulation voltage to the reconfigurable intelligent surface in the diffraction modulation module 171 to realize phase modulation of the incident wave by the reconfigurable intelligent surface.

Each detection area in the detection module 172 is provided with a detector, and the detector is configured to measure the intensity of the electromagnetic field in the detection area to which the detector belongs. Unlike the detection module 202 in FIG. 2, the detection module 172 according to this embodiment of the present disclosure directly outputs the intensity measurement value of the electromagnetic field in each detection area and sends it to the control module 173. It is appreciated that the embodiments of the present disclosure do not impose restrictions on the number of the detection areas in the detection module 172 or the specific hardware structure.

According to one possible implementation, the determination of the DOAs corresponding to the N signal sources based on the intensity measurement value of the electromagnetic field in each detection area sent by the detection module 172 may, for example, comprise determining the DOAs corresponding to the N signal sources based on the angle intervals corresponding to the N detection areas with the greatest intensity measurement values. For example, the intermediate values of the angle intervals corresponding to the N detection areas with the greatest intensity measurement values may be taken as the DOAs corresponding to the N signal sources.

In practical application, the DOA corresponding to the signal source is within a preset angle range, the preset angle range is the maximum angle range that can be estimated by the DOA estimation system, the preset angle range may include a plurality of angle intervals, and each detection area in the detection module 172 may correspond to one angle interval. Directly adopting the method of selecting the angle intervals corresponding to the N detection areas with the greatest intensity measurement values to determine the DOAs corresponding to the N signal sources may lead to misclassification. For example, when a detection area with the greatest intensity measurement value is to be found among a plurality of detection areas to determine the DOA of the signal source, the DOA at the boundary of the angle interval may easily be wrongly classified into an adjacent angle interval, which will lead to the decline of DOA estimation accuracy. Thus, in order to improve the estimation accuracy of the DOA estimation system, an embodiment of the present disclosure proposes a flexible decision boundary strategy, which correctly classifies the DOA at the interval boundary by comparing an intensity ratio between the two greatest intensity measurement values with a pre-calibrated preset decision coefficient, thereby effectively improving the estimation accuracy of the DOA estimation system, and solving the misclassification problem when the DOA of a single signal source is located at the interval boundary. Specifically, according to one possible implementation, the determination of the DOAs corresponding to the N signal sources based on the intensity measurement value of the electromagnetic field in each detection area sent by the detection module 172 may comprise:
in response to N being 1, determining a greatest intensity measurement value and a second greatest intensity measurement value from the intensity measurement values of the electromagnetic fields in the respective detection areas sent by the detection module 172, and determining whether the detection area to which the greatest intensity measurement value belongs is adjacent to the detection area to which the second greatest intensity measurement value belongs;
in the case where the detection area to which the greatest intensity measurement value belongs is not adjacent to the detection area to which the second greatest intensity measurement value belongs, determining the DOA corresponding to the signal source based on the angle interval corresponding to the detection area to which the greatest intensity measurement value belongs; and
in the case where the detection area to which the greatest intensity measurement value belongs is adjacent to the detection area to which the second greatest intensity measurement value belongs, calculating an intensity ratio of the greatest intensity measurement value to the second greatest intensity measurement value; and determining the DOA corresponding to the signal source based on a relative magnitude between the intensity ratio and a preset decision coefficient, wherein the preset decision coefficient is obtained by calculating an intensity ratio between the electromagnetic fields in adjacent detection areas corresponding to adjacent angle intervals when the DOA of the incident wave is located at an angle of intersection between the adjacent angle intervals.

N being 1 implies that the system estimates the DOA of a signal source. The flexible decision-making approach proposed in the embodiment of the present disclosure may be adapted to a task of DOA estimation of a single signal source. If the detection area to which the greatest intensity measurement value belongs is not adjacent to the detection area to which the second greatest intensity measurement value belongs, it means that the DOA of the signal source is not located at the interval boundary of the angle interval, at which point the angle interval corresponding to the detection area to which the greatest intensity measurement value belongs may be directly selected to determine the DOA of the signal source. For example, the intermediate value of the angle interval may be used as the DOA of the signal source.

If the detection area to which the greatest intensity measurement value belongs is adjacent to the detection area to which the second greatest intensity measurement value belongs, it means that the DOA of the signal source may be located at the interval boundary of the angle interval. For example, a DOA of 44.6° is at the interval boundary of the angle intervals of [35°, 45° ] and [45°, 55°], and the signal source may be classified into the angle interval of [45°, 55° ] by directly selecting the detection area with the greatest intensity measurement value. Therefore, a preset decision coefficient may be obtained in advance by calculating the intensity ratio between the electromagnetic fields in the adjacent detection areas corresponding to each set of adjacent angle intervals when the DOA of the signal source is located at the angle of intersection between each set of adjacent angle intervals, and then the DOA corresponding to the signal source may be determined by comparing the intensity ratio between the greatest intensity measurement value and the second greatest intensity measurement value with the preset decision coefficient.

The preset decision coefficient may be interpreted as the intensity ratio between the electromagnetic fields in the adjacent detection areas corresponding to adjacent angle intervals when the DOA of the incident wave is located at the angle of intersection between the adjacent angle intervals. For example, for two adjacent angle intervals of [35°, 45° ] and [45°, 55°], the angle of intersection between the two adjacent angle intervals is 45°, and thus an incident wave having a DOA of 45° may be controlled in advance to enter the DOA estimation system to obtain intensity measurement values of the electromagnetic fields in two detection areas corresponding to the two adjacent angle intervals, and then an intensity ratio between the intensity measurement values of the electromagnetic fields in the two adjacent detection areas is calculated to obtain a preset decision coefficient corresponding to the angle of intersection between the two adjacent angle intervals. It is appreciated that for an angle of intersection between every two adjacent angle intervals within a preset angle range, a preset decision coefficient corresponding to the angle of intersection between every two adjacent angle intervals may be calculated, and the preset decision coefficient corresponding to each angle of intersection within the preset angle range may be stored in the control module 173, so that the control module 173 may perform accurate estimation based on the DOA of any unknown signal source.

By way of example, the following Formula (6) may be used to calculate the intensity ratio between the intensity measurement values of the electromagnetic fields in any two adjacent detection areas:

$$log ( {P}_{i} / {P}_{i + 1} ) = log ( {P}_{i} ) - log ( {P}_{i + 1} ) \qquad ( 6 )$$

where Pᵢ and Pᵢ₊₁ respectively represent the intensity measurement values of the electromagnetic fields in two adjacent detection areas, and log(Pᵢ/Pᵢ₊₁) represents the intensity ratio between Pᵢ and Pᵢ₊₁. It is appreciated that the calculation method of the intensity ratio shown in Formula (6) is a possible implementation provided by the embodiment of the present disclosure. In fact, a person skilled in the art may adopt a calculation method known in the art. For example, Pᵢ/Pᵢ₊₁ may be directly used as the intensity ratio between the electromagnetic fields in two adjacent detection areas, which is not limited by the embodiments of the present disclosure.

Optionally, the above Pᵢ may be the greatest intensity measurement value, and Pᵢ₊₁ may be the second greatest intensity measurement value. Therefore, the determination of the DOA corresponding to the signal source based on the relative magnitude between the intensity ratio and the preset decision coefficient comprises: determining the DOA corresponding to the signal source based on the angle interval corresponding to the detection area to which the greatest intensity measurement value belongs when the intensity ratio is greater than the preset decision coefficient; and determining the DOA corresponding to the signal source based on the angle interval corresponding to the detection area to which the second greatest intensity measurement value belongs when the intensity ratio is smaller than or equal to the preset decision coefficient, wherein the DOA corresponding to the signal source includes an intermediate value of the angle interval. It is appreciated that since this method calculates the ratio of the greatest intensity measurement value to the second greatest intensity measurement value, if the intensity ratio is greater than the preset decision coefficient, it means that the signal source is closer to the angle interval corresponding to the detection area to which the greatest intensity measurement value belongs, and conversely, if the intensity ratio is smaller than the preset decision coefficient, it means that the signal source is closer to the angle interval corresponding to the detection area to which the second greatest intensity measurement value belongs.

Optionally, the above P; may be the second greatest intensity measurement value, and Pᵢ₊₁ may be the greatest intensity measurement value. Therefore, the determination of the DOA corresponding to the signal source based on the relative magnitude between the intensity ratio and the preset decision coefficient comprises: determining the DOA corresponding to the signal source based on the angle interval corresponding to the detection area to which the second greatest intensity measurement value belongs when the intensity ratio is greater than the preset decision coefficient; and determining the DOA corresponding to the signal source based on the angle interval corresponding to the detection area to which the greatest intensity measurement value belongs when the intensity ratio is smaller than or equal to the preset decision coefficient. It is appreciated that since this method calculates the ratio of the second greatest intensity measurement value to the greatest intensity measurement value, if the intensity ratio is greater than the preset decision coefficient, it means that the signal source is closer to the angle interval corresponding to the detection area to which the second greatest intensity measurement value belongs, and conversely, if the intensity ratio is smaller than the preset decision coefficient, it means that the signal source is closer to the angle interval corresponding to the detection area to which the greatest intensity measurement value belongs.

The above flexible decision boundary strategy provided by the embodiment of the present disclosure may be briefly described as follows: for an incident wave from a signal source with an unknown DOA, intensity measurement values, i.e., Pᵢ and Pⱼ, of two detection areas of i and j (i<j) with the greatest electromagnetic field intensity and second greatest electromagnetic field intensity are determined, which correspond to an i-th angle interval and a j-th angle interval, respectively. If the two detection areas are not adjacent, i.e., j≠i+1, the detection area with the greatest intensity measurement value is used to determine the angle interval to which the signal source belongs. If the two detection areas are adjacent, i.e., j=i+1, it implies that the DOA of the signal source may be located at the interval boundary, and then an intensity ratio between the electromagnetic fields in the two detection areas is calculated, i.e., log(Pᵢ/Pᵢ₊₁)=log(Pᵢ)−log(Pᵢ₊₁), and a comparison is made between the intensity ratio and a pre-calibrated preset decision coefficient ξ_{i,i+1} which represents a preset decision coefficient corresponding to an angle of intersection between the i-th angle interval and the (i+1)-th angle interval. If the intensity ratio is greater than ξ_{i,i+1}, the signal source is classified into the i-th angle interval; otherwise, the signal source is classified to the (i+1)-th angle interval. The above flexible decision boundary strategy may be used to improve the performance of DOA estimation for a single-signal source of the DOA estimation system, and may effectively improve the confidence and accuracy of the DOA estimation system in realizing DOA estimation for a single-signal source.

In order to further improve the angle estimation accuracy of the DOA estimation system, an embodiment of the present disclosure further provides a photoelectric combination strategy, which may greatly improve the angle estimation accuracy on the premise of ensuring a wide field of view without an additional space-time multiplexing mechanism. The photoelectric combination strategy needs to take the electromagnetic field intensity of electromagnetic waves with different angles respectively measured in the respective detection areas of the detection module 172 using the DOA estimation system as prior information, to construct an intensity-angle characteristic curve, and to find a prior DOA that best matches an intensity response of an unknown signal source to serve as the DOA of the unknown signal source based on the intensity-angle characteristic curve. Specifically, assuming that the detection module 172 comprises K detection areas, with K≥N, K intensity-angle characteristic curves corresponding to the K detection areas are stored in advance in the control module 173, and a k-th intensity-angle characteristic curve is configured to represent a mapping relationship between each of a plurality of prior DOAs within a preset angle range and prior intensity value of an electromagnetic field of each incident wave having respective prior DOA in the k-th detection area, wherein k∈[1,K].

In practical application, the K intensity-angle characteristic curves may be constructed in advance by means of experimental measurements, etc. For example, for a DOA estimation system configured to perform estimation within a preset angle range of [−15°, 15°], the electromagnetic field intensity in the K detection areas in the detection module 172 when incident waves with 121 different angles are collected uniformly at intervals of 0.25° in the range of [−15°, 15°] may be used as prior intensity values, with the 121 different angles serving as prior DOAs. Then, the cubic interpolation method may be used to interpolate the prior intensity values in the K detection areas corresponding to the 121 discrete prior DOAs, so as to fit K intensity-angle characteristic curves of the DOA estimation system in the whole preset angle range. That is, taking the 121 prior DOAs as the abscissa, 121 prior intensity values measured in each detection area are interpolated and fitted as the ordinate to obtain the intensity-angle characteristic curve corresponding to each detection area. The intensity-angle characteristic curve may describe a response of the DOA estimation system to the electromagnetic field intensity of signal sources with different angles, that is, the electromagnetic field intensity is the highest in the detection area corresponding to the angle interval in which the signal source is located. The K intensity-angle characteristic curves constitute a K-dimensional energy space, and K prior intensity values of different DOAs may be regarded as the coordinates of corresponding angles in the K-dimensional energy space. For an unknown incident wave, the intensity measurement values in the K detection areas may correspond to any point in the K-dimensional energy space, and a prior point with the shortest Euclidean distance corresponding to the incident wave may be calculated, for example, by using the least square method, and then a corresponding prior DOA is found on the intensity-angle characteristic curve as the result of the DOA estimation of the signal source.

Therefore, the determination of the DOAs corresponding to the N signal sources based on the intensity measurement value of the electromagnetic field in each detection area sent by the detection module 172 may comprise: for each prior DOA within the preset angle range, calculating error values between the K prior intensity values corresponding to each prior DOA on the K intensity-angle characteristic curves and the intensity measurement values of the electromagnetic fields in the K detection areas sent by the detection module to obtain the error values corresponding to each prior DOA; and the N prior DOAs with the smallest error values are selected as the DOAs corresponding to the N signal sources. In this way, DOA estimation with higher accuracy may be achieved.

By way of example, assuming that the detection module 172 comprises ten detection areas, that is, there are ten intensity-angle characteristic curves, for a prior DOA of “−14.75°” in a preset angle range of [−15°, 15°], the prior DOA of “−14.75°” corresponds to ten prior intensity values on ten intensity-angle characteristic curves, respectively, and the detection module 172 measures ten intensity measurement values of the electromagnetic fields in ten detection areas, and then an error calculation method such as the least square method may be employed to calculate error values between the ten prior intensity values and the ten intensity measurement values to obtain the error values corresponding to the prior DOA of “−14.75°”. With the above method, the error value corresponding to each of the 121 prior DOAs in the preset angle range of [−15°, 15° ] may be calculated, and then for N signal sources, the first N prior DOAs, with the error values arranged from small to large, may be selected as the DOAs corresponding to the N signal sources, that is, the N prior DOAs with the smallest error values may be selected as the DOAs corresponding to the N signal sources.

The above photoelectric combination strategy may be used to improve the performance of the DOA estimation system in DOA estimation for multiple-signal sources. Utilizing the photoelectric combination strategy requires only a small amount of electronic computation, and thus the estimation performance of the DOA estimation system, including the root mean square error (RMSE) and the confidence, may be significantly improved. For example, within the above preset angle range of [−15°, 15° ], the use of the photoelectric combination strategy is able to improve the RMSE index of the DOA estimation accuracy to 0.19°, as well as able to improve the confidence of the DOA estimation system on DOA estimation for multiple-signal sources from 94.9% to 99.5%, and encompassing angles at interval boundaries and all permutations and combinations of angles.

According to one possible implementation, the angular resolution corresponding to the above preset angle range may be smaller than the diffraction limit angle, and the angular resolution represents the magnitude of the angle interval. That is, the above DOA estimation system 170, in combination with the above flexible decision boundary strategy or photoelectric combination strategy, is able to achieve a higher precision super-resolution DOA estimation effect.

As mentioned above, the DOA includes a pitch angle and/or an azimuth angle, and the control module 173 may also be configured to control the diffraction modulation module 171 to rotate by 90° to switch between the estimation of the pitch angle and the estimation of the azimuth angle. For the diffraction modulation module 171 composed of passive intelligent surfaces, an electric rotating member may be provided to control the diffraction modulation module 171 to rotate, that is, the diffraction modulation module 171 may be connected to an electric rotating member, and the control module 173 may control the electric rotating member to cause the diffraction modulation module 171 to rotate by sending an instruction to the electric rotating member. For the diffraction modulation module 171 composed of reconfigurable intelligent surfaces, the control module 173 may switch between estimation of the pitch angle and estimation of the azimuth angle by changing the modulation voltage of the liquid crystal phase shift layer. For example, adjusting the modulation voltage used in estimating the pitch angle to a modulation voltage used in estimating the azimuth angle is equivalent to controlling the diffraction modulation module 171 to rotate by 90°. It is appreciated that during the modeling optimization process of the diffraction modulation module 171, two sets of model parameters (thickness of material and modulation voltage) may be determined for the pitch angle and the azimuth angle, respectively, so as to facilitate the respective estimation of the pitch angle and the azimuth angle.

As mentioned above, after the DOA corresponding to the signal source is estimated, it is generally possible to perform beamforming on the incident wave of the signal source based on the DOA of the signal source in order to enhance the communication signal transmission. Thus, according to one possible implementation, in the case where the diffraction modulation module 171 comprises at least one layer of cascaded passive intelligent surface, the system further comprises:
a beamforming module 174 which comprises a reconfigurable intelligent surface, the reconfigurable intelligent surface in the beamforming module 174 being configured to perform beamforming on the incident wave.

Therefore, the control module 173 is further configured to determine a control voltage required for beamforming incident waves emitted by N signal sources based on DOAs corresponding to the N signal sources and a direction angle corresponding to a signal receiver, and apply the control voltage to the reconfigurable intelligent surface in the beamforming module 174, so that the reconfigurable intelligent surface in the beamforming module 174 is able to beamform the incident waves and reflect the beamformed incident waves to the signal receiver.

According to one possible implementation, in the case where the diffraction modulation module 171 comprises a reconfigurable intelligent surface, the control module 173 is further configured to determine a control voltage required for beamforming the incident waves emitted by N signal sources based on DOAs corresponding to the N signal sources and a direction angle corresponding to a signal receiver, and apply the control voltage to the reconfigurable intelligent surface in the diffraction modulation module 171, so that the reconfigurable intelligent surface in the diffraction modulation module 171 beamforms the incident waves and reflects the beamformed incident waves to the signal receiver.

By referring to the method of realizing beamforming by using the beamforming module 203 and the diffraction modulation module 201 in the above embodiment of the present disclosure, beamforming may be realized by using the beamforming module 174 and the control module 173, or beamforming may be realized by using the diffraction modulation module 171 and the control module 173, which will not be described in detail here.

According to the DOA estimation system of the embodiment of the present disclosure, the phase distribution of electromagnetic field of the incident wave is modulated by the diffraction modulation module 171 to focus the incident wave on the detection module 172, the detection module 172 measures the electromagnetic field intensity in each detection area and sends the electromagnetic field intensity measurement in each detection area to the control module 173, and the control module 173 determines the DOA of the signal source based on the intensity measurement value of the electromagnetic field in each detection area, thereby enabling DOA estimation with low latency, low power consumption, low cost, and higher precision.

FIG. 18 shows some application scenarios in which the above DOA estimation system is used. As shown in FIG. 18, at A, two sets of DOA estimation systems that are spatially multiplexed are used to fulfill a task of DOA estimation for multiple-signal sources with a field of view of 1000 and an angular resolution of 10° in a two-dimensional estimation mode, and the two sets of DOA estimation systems may also be used to estimate a direction angle in the horizontal direction and a pitch angle in the vertical direction, respectively; B represents that the DOA estimation system (S-DNN for short) according to the embodiment of the present disclosure may perform all-optical DOA estimation on any mobile signal source (such as an aircraft); based on the temporal or spatial multiplexing mechanism, the application of the DOA estimation system, S-DNN, according to the embodiment of the present disclosure in the communication system may be as shown by C and D in FIG. 18, wherein in FIG. 18, at C, a reconfigurable S-DNN (i.e., a DOA estimation system constructed by a reconfigurable intelligent surface) is used to perform the DOA estimation task and the beamforming task under the time division multiplexing mechanism, that is, by using the reconfigurable S-DNN, the DOA estimation may be carried out for high-speed rails and signals sent from the base station may be beamformed and reflected to the high-speed rails. In FIG. 18, at D, the DOA estimation task is performed using a passive S-DNN (i.e., a DOA estimation system consisting of multiple layers of passive intelligent surfaces, PIS), and further with a reconfiguration intelligent surface (LC RIS, i.e., a liquid crystal RIS) for beamforming, the beamforming task is fulfilled. Here, the passive S-DNN may be used to estimate the DOA of the user terminal, and the estimated angle is sent to the LC RIS so that the LC RIS may beamform the signal sent by the base station and reflect it to the user terminal. The number of layers of the passive intelligent surfaces in the passive S-DNN may be increased. For example, three layers of passive intelligent surfaces and four layers of passive intelligent surfaces are able to realize DOA estimation with angular resolutions of 3° and 1° (which exceeds the diffraction limit angle) over any local field of view of 300 and 10°. At E in FIG. 18, it is a conventional RIS-based communication system, in which the base station is required to carry out conventional wireless signal processing procedures such as frequency conversion, sampling, and digital signal processing in order to perform DOA estimation, and the base station needs to send the DOA estimation result to the reconfigurable intelligent surface, and the reconfigurable intelligent surface beamforms the electromagnetic waves emitted by the base station and reflects them to an autonomous vehicle terminal under wired control of the base station, so as to establish the communication link between the base station and the vehicle terminal. Different from the conventional RIS-based communication system shown at E, the DOA estimation system, S-DNN, according to the embodiment of the present disclosure is able to provide all-optical perception capability and edge computing capability for the communication system, and the base station does not need to perform signal processing or send the DOA estimation result to the reconfigurable intelligent surface, which is beneficial to realize low-latency beam tracking and real-time communication between the base station and high-speed mobile users.

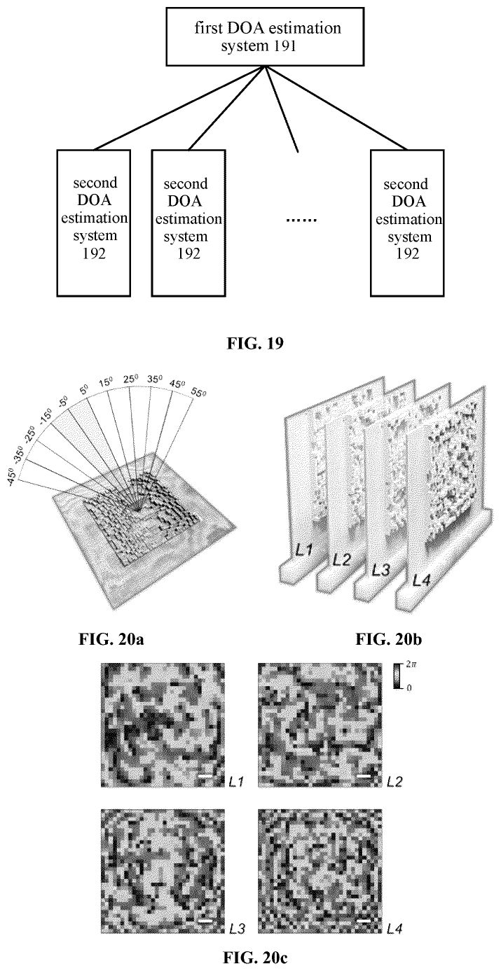

Considering that the use of one set of DOA estimation system in a practical situation may not be able to realize DOA estimation with both a broad angle range and a small angular resolution, according to one possible implementation it is possible to perform coarse-to-fine DOA estimation by means of at least two sets of DOA estimation systems, enabling super-resolution DOA estimation over a wide field of view. That is, super-resolution DOA estimation over a wide field of view may be achieved by using DOA estimation systems with different angular resolutions and preset angle ranges. Thus, an embodiment of the present disclosure further provides a super-resolution DOA estimation device as shown in FIG. 19, comprising:
a single first DOA estimation system 191 configured to estimate DOAs in I angle intervals of a preset angle range, with I being a positive integer; and
I second DOA estimation systems 192, wherein an i-th second DOA estimation system 192 is configured to estimate DOAs in J sub-angle intervals of an i-th angle interval in the I angle intervals, with i∈[1, I] and J being a positive integer,
wherein the first DOA estimation system 191 and the second DOA estimation systems 192 are any of the DOA estimation systems provided by the above embodiments of the present disclosure, that is, for example, the DOA estimation system shown in FIG. 2 or the DOA estimation system shown in FIG. 17 may be adopted, which is not limited by the embodiments of the present disclosure. The DOA estimation processes of the first DOA estimation system 191 and the second DOA estimation systems 192 may refer to the relevant descriptions of the DOA estimation systems provided by the above embodiments of the present disclosure, and will not be repeatedly described herein.

The first DOA estimation system 191 is configured to estimate DOAs within I angle intervals of a preset angle range. This may be understood in such a way that a detection module in the first DOA estimation system 191 comprises I detection areas, and each detection area corresponds to one angle interval, so the first DOA estimation system 191 is able to estimate the DOAs in I angle intervals of the preset angle range. In order to estimate the DOA with a smaller angular resolution, I second DOA estimation systems 192 are used to perform more accurate DOA estimation on the DOAs in the I angle intervals, respectively, a preset angle range estimated by the i-th second DOA estimation system is the i-th angle interval, and the i-th angle interval may be divided into J sub-angle intervals with a smaller angular resolution, so that the I second DOA estimation systems 192 may be used to divide the signal source into sub-angle intervals with a smaller angular resolution to obtain a more accurate DOA.

Optionally, the magnitude of the I angle intervals may be greater than or equal to the diffraction limit angle, and the magnitude of the J sub-angle intervals may be smaller than the diffraction limit angle. It is appreciated that those skilled in the art may determine the angle ranges and the angular resolutions that can be respectively estimated by the first DOA estimation system 191 and the respective second DOA estimation systems 192 based on the actual needs. For example, in order to realize a DOA estimation with a preset angle range of [−45°, 55° ] and an angular resolution of 1°, the first DOA estimation system 191 may employ a single layer of passive intelligent surface as shown in FIG. 20a to realize a DOA estimation with an angular resolution of 10° and a preset angle range of [−45°, 55° ]. That is, a single layer of passive intelligent surface with an angular resolution of 10° may first be used to cover the entire preset angle range, and ten second DOA estimation systems 102 may then be employed, each of which may employ the four layers of passive intelligent surfaces as shown in FIG. 20b (FIG. 20c shows the distribution of phase modulation values of the four layers of passive intelligent surfaces), in order to realize DOA estimation of 10 sub-angle intervals with an angular resolution of 1° in each of the ten angle intervals of “[−45°+10y, −35°+10y], y=0, . . . , 9”. For example, the first second DOA estimation system may estimate the DOAs in 10 sub-angle intervals having an angular resolution of 10 in a first angle interval of [−45°, −35° ], and so on until the tenth second DOA estimation system may estimate the DOAs in the 10 sub-angle intervals having an angular resolution of 10 in the tenth angle interval of [45°, 55° ], whereby the single first DOA estimation system 191 and the ten second DOA estimation systems 192 may be used to realize DOA estimation with a preset angle range of [45°, 55° ] and an angular resolution of 1°.

It is appreciated that the above use of a single layer of passive intelligent surface to constitute the first DOA estimation system 191 and the above use of four layers of passive intelligent surfaces to constitute the second DOA estimation system 192 are one possible implementation provided by the embodiment of the present disclosure. In fact, a reconfigurable intelligent surface may also be used in the first DOA estimation system 191, and a reconfigurable intelligent surface may also be used in the second DOA estimation system 192. For example, the first DOA estimation system 191 may use a reconfigurable intelligent surface, and the second DOA estimation system 192 may use four layers of passive intelligent surfaces; or the first DOA estimation system 191 may use a single layer of passive intelligent surface, and the second DOA estimation system 192 may use four layers of passive intelligent surfaces, that is, any combination is possible as long as it is able to execute the required DOA estimation function at different angular resolutions, and the embodiments of the present disclosure impose no restrictions on this.

According to one possible implementation, the first DOA estimation system 191 may be configured to control an m-th second DOA estimation system 192 for estimating the DOA in an m-th angle interval to perform DOA estimation when the DOA corresponding to the signal source is estimated to belong to the m-th angle interval, wherein m∈[1, I]; and the m-th second DOA estimation system 192 may be configured to determine a sub-angle interval to which the DOA corresponding to the signal source belongs, and determine the DOA corresponding to the signal source based on the sub-angle interval to which the DOA corresponding to the signal source belongs. This method may be understood in such a way that when the first DOA estimation system 192 estimates that the DOA corresponding to the signal source belongs to a certain angle interval, the second DOA estimation system corresponding to the angle interval is actuated to perform finer-grained DOA estimation, thus realizing low power and high-precision DOA estimation. For example, if the first DOA estimation system 191 estimates that the signal source belongs to a first angle interval of “[−45°, −35° ]”, the first DOA estimation system 191 may control the first second DOA estimation system 192 for estimating the first angle interval of “−45°, −35°]” to actuate DOA estimation, and the first second DOA estimation system 192 may determine a sub-angle interval to which the DOA corresponding to the signal source belongs, and determine the DOA corresponding to the signal source based on the sub-angle interval to which the signal source belongs. For example, if the 1st second DOA estimation system determines that the DOA corresponding to the signal source belongs to a sub-angle interval of [−40°, −39°], the 1st second DOA estimation system may output that the DOA corresponding to the signal source is an intermediate value of the sub-angle interval of [−40°, −39° ], i.e., −39.5°.

As described above, the DOA estimation system provided by the embodiment of the present disclosure is able to estimate DOAs of one or more signal sources. Therefore, for each signal source among a plurality of signal sources, the first DOA estimation system 191 may estimate an angle interval to which the DOA corresponding to each signal source belongs, and if there are N signal sources, it may estimate N angle intervals, and then may control N second DOA estimation systems 192 corresponding to the N angle intervals to which the N signal sources belong to start the DOA estimation.

It is appreciated that since the reconfigurable intelligent surface may be used in the first DOA estimation system 191 and the second DOA estimation systems 192, the super-resolution DOA estimation device provided by the embodiment of the present disclosure may be used not only for estimating the DOA, but also for beamforming. For details, reference can be made to the relevant descriptions about beamforming in the above embodiments of the present disclosure, and no further elaboration will be provided here.

According to the super-resolution DOA estimation device provided by the embodiment of the present disclosure, the coarse-to-fine DOA estimation may be performed using multiple types of DOA estimation systems based on the space-time multiplexing mechanism, so that the super-resolution DOA estimation over a wide field of view may be realized, with the advantages of low cost, low latency, and low power consumption.

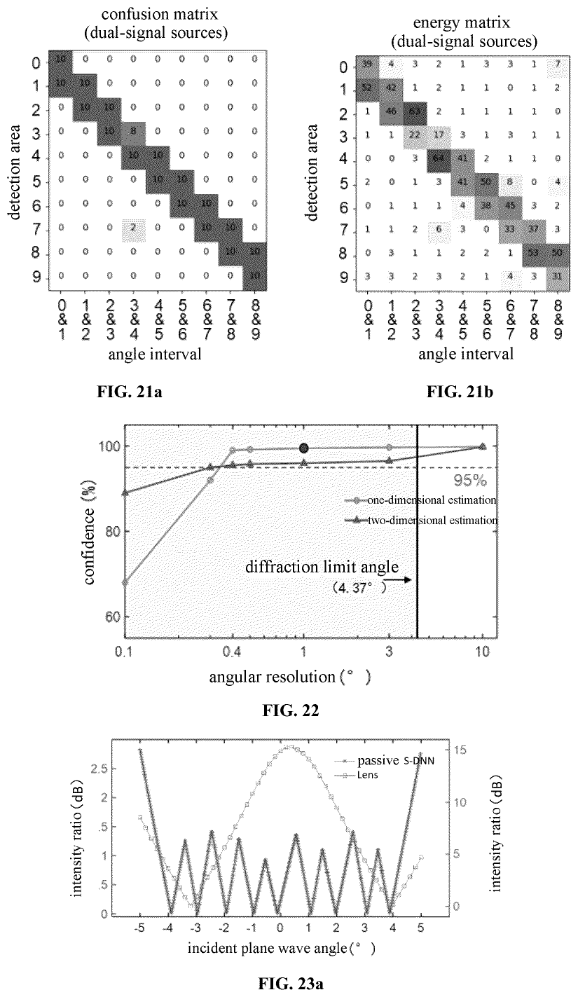

The embodiments of the present disclosure further provide some experimental results to demonstrate the high confidence and high accuracy of the super-resolution DOA estimation system. FIG. 21a and FIG. 21b respectively show the experimental results of a confusion matrix and an energy matrix obtained by a reconfigurable intelligent surface, with an angular resolution of 10°, estimating a pitch angle within [−45°, 55° ]. The experimental results count 100 sets of dual-signal source test samples, demonstrating the high confidence and the high average energy percentage of correct angle classification of the reconfigurable intelligent surface with an angular resolution of 10°. Moreover, DOA estimation for a single-signal source over fields of view of 150° and 30°, corresponding to angular resolutions of 15° and 3°, may also be realized by providing the first DOA estimation system 191 with a single layer of reconfigurable intelligent surface. After the single layer of reconfigurable intelligent surface achieves wide-field-of-view coverage, four layers of passive intelligent surfaces may be provided in the second DOA estimation system 192 to perform super-resolution DOA estimation with an angular resolution of 1° and an angle range of [−5°, 5° ]. It is appreciated that other different angle intervals of 10°, such as the angle interval of [45°, 55° ], may also be realized by providing different passive intelligent surfaces. The dual adaptive training (DAT) method may be used to optimize the model parameters to reduce the model bias. The position of each detection area in the detection module may be fine-tuned in the experiments. The DAT optimization process may be supervised by obtaining full-wave electromagnetic field simulation results using the time-domain finite integration method in the CST Studio Suite tool.

The embodiments of the present disclosure further evaluate the performance of the four layers of passive intelligent surfaces in DOA estimation with different angular resolutions in a one-dimensional estimation mode and a two-dimensional estimation mode, by taking the angle classification accuracy computed from the mean square error (MSE) loss function as confidence, and obtain the evaluation result as shown in FIG. 22. As shown in FIG. 22, when the angular resolution is greater than 0.4°, the confidence exceeds 95%, or when the confidence threshold is 95%, the angular resolution of the angles that can be estimated by the four layers of passive intelligent surfaces in the one-dimensional estimation mode and the two-dimensional estimation mode may reach 0.4°, which is one tenth of the diffraction limit angle (4.37°) defined by the Rayleigh criterion. The angle classification accuracy of multiple layers of passive intelligent surfaces may be evaluated based on the MSE loss function, which is more robust. By increasing the scale of the passive intelligent surface, the angular resolution that the passive intelligent surface is able to estimate may be further optimized. For example, the cross entropy loss function may be used to optimize the model parameters to increase the scale, so that the angular resolution that can be estimated by the multiple layers of passive intelligent surfaces is 40˜70 times less than the Rayleigh limit.

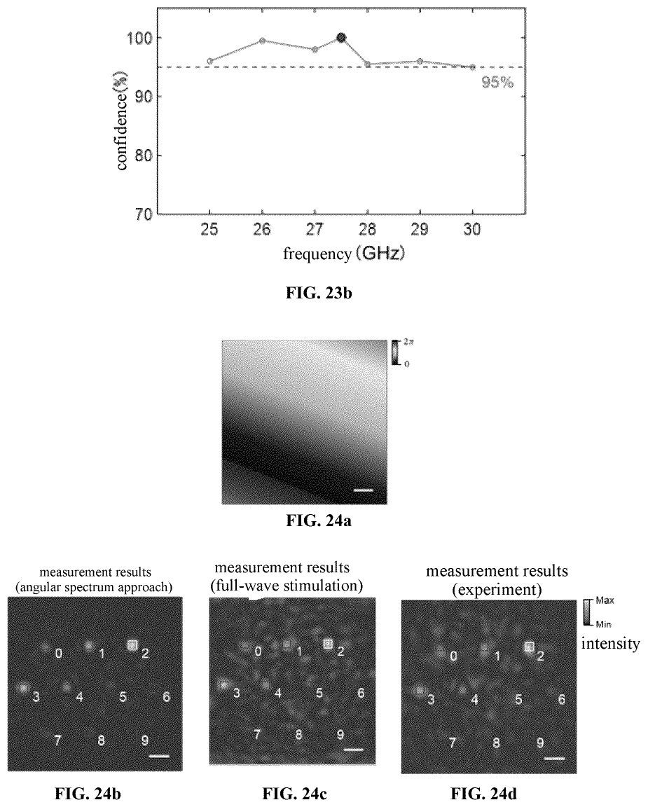

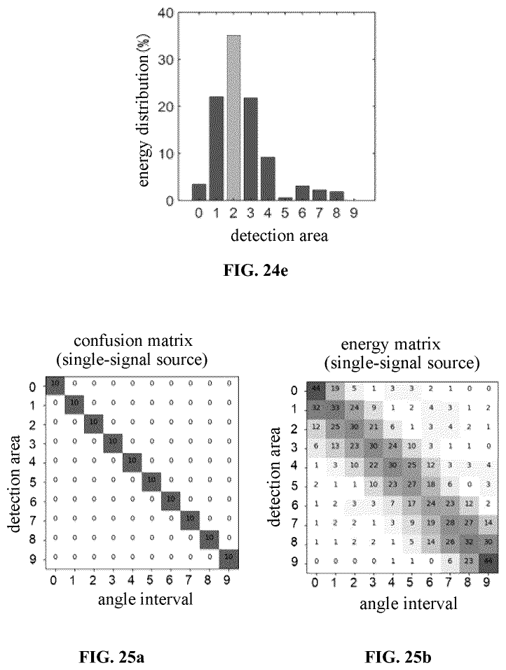

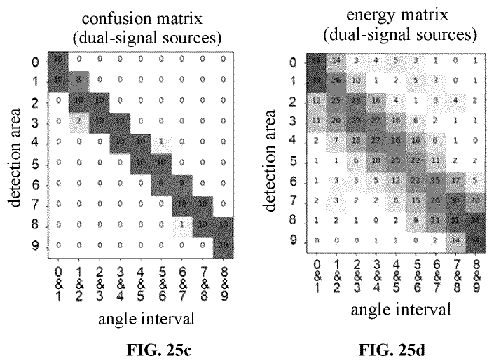

FIG. 23a shows a comparison between the angular response of four layers of passive intelligent surfaces (passive S-DNN) and the angular response of an existing lens system (i.e., Lens) to different incident plane wave angles, by calculating an intensity ratio of a detection area with the greatest electromagnetic field intensity to a detection area with the second greatest electromagnetic field intensity. As can be seen from FIG. 23a, compared with the lens system, the passive intelligent surface is able to generate a super-oscillation angular response in a local angle interval by using a multi-layer sub-wavelength diffraction unit, thus enabling the super-resolution DOA estimation. FIG. 23b shows the confidence of the DOA estimation for a single-signal source by the four layers of passive intelligent surfaces in a broadband range of 25 GHz to 30 GHz. The experimental results demonstrate that the confidence of the DOA estimation for a single-signal source by the four layers of passive intelligent surfaces in the broadband range of 25 GHz to 30 GHz is higher than 95%. Numerical evaluation may be performed on 10,000 sets of test samples based on the angular spectrum method, and the performance may be verified on 100 sets of test samples in solid experiments and using the full-wave simulation technology. Specifically, for the phase distribution of electromagnetic field of the incident wave having a pitch angle of −2.5° and an azimuth angle of 1° shown in FIG. 24a, three electromagnetic field intensity measurement results shown in FIG. 24b, FIG. 24c, and FIG. 24d may be obtained by using four layers of passive intelligent surfaces. FIG. 24b shows the measurement results of the electromagnetic field intensity in 10 detection areas obtained by the angular spectrum method, FIG. 24c shows the measurement results of the electromagnetic field intensity in 10 detection areas obtained by the full-wave simulation method, FIG. 24d shows the measurement results of the electromagnetic field intensity in 10 detection areas obtained from the solid experiments using four layers of passive intelligent surfaces, and FIG. 24e shows the energy distribution of the electromagnetic field intensity in the 10 detection areas. As can be seen from FIG. 24b, FIG. 24c, FIG. 24d, and FIG. 24e, for the pitch angle estimation of a signal source with a pitch angle of −2.5° and an azimuth angle of 1°, the measurement results obtained during the two simulation modeling are highly similar to the measurement results output by the solid experiments, i.e., both having the greatest electromagnetic field intensity (that is, the greatest energy value) in the detection area numbered 2 corresponding to the angle interval of [−3°, −2° ], so the results of DOA estimation are correct. The high similarity between the numerical values and experimental results proves the robustness of the four layers of passive intelligent surfaces. Based on the angular spectrum method, it is estimated that the confidence (i.e., the accuracy of angle classification) of the four layers of passive intelligent surfaces may reach 99.3% and 99.0% on a single-signal source test dataset and a double-signal source test dataset, respectively. The central angle of the angle interval may be used as the result of DOA estimation, and the RMSE may be used to evaluate the accuracy of angle estimation. Thus, the accuracy of angle estimation in the full-wave simulation mode may reach 0.23° and 0.24°, and the average energy percentage of the correct detection areas may reach 34.6% and 29.8%. In a dual-signal source test dataset, each set includes two signal sources distributed in adjacent angular intervals. During an experiment on four layers of passive intelligent surfaces using the experimental equipment shown in FIG. 5, source signals generated by a vector network analyzer are connected, through a power splitter, to two horn antennas spaced 1° apart to serve as two signal sources, and by controlling an angle turntable to rotate in a uniform step size within a field of view, test samples with different angles are generated. The experimental results provide a confusion matrix shown in FIG. 25a and an energy matrix shown in FIG. 25b corresponding to a single-signal source, a confusion matrix shown in FIG. 25c and an energy matrix shown in FIG. 25d corresponding to dual-signal sources, and it can be seen from FIG. 25a to FIG. 25d that the four layers of passive intelligent surfaces demonstrate high confidence and high accuracy in DOA estimation with an angular resolution of 1°.

The super-resolution DOA estimation device according to the embodiment of the present disclosure directly processes electromagnetic waves by constructing a DOA estimation system to realize all-optical DOA estimation at the speed of light. The multilayer metasurface structure of the diffraction modulation module in the DOA estimation system is able to generate a super-oscillation angular response in a local angle interval, so that DOA estimation may be performed with an angular resolution beyond the diffraction limit. High-resolution DOA estimation over a wide field-of-view range may be achieved by using the space-time multiplexing mechanism of the passive intelligent surface and the reconfigurable intelligent surface. The embodiments of the present disclosure verify that the super-resolution DOA estimation device is able to perform DOA estimation on multiple radio signal sources over a 5 GHz frequency bandwidth with a response time of about 67 ns, as well as demonstrate that the angular resolution of the angle range that the super-resolution DOA estimation device is able to estimate may exceed the diffraction limit by more than ten times, and demonstrate results exceeding the diffraction limit angle by four times. In addition, the application of the all-optical edge computing capability of the super-resolution DOA estimation device, assisted by a reconfigurable intelligent surface, enables the realization of an extremely low latency communication and perception integrated system. Compared with electronic computing, the super-resolution DOA estimation device according to the embodiment of the present disclosure has advantages in both computing mode and performance, and represents an important step towards facilitating various wireless perception and communication tasks with all-optical processors.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to those skilled in the art.

What is claimed is:

1. A system for direction of arrival, DOA, estimation, comprising:
a diffraction modulator configured to modulate phase distribution of electromagnetic fields of incident waves emitted by N signal sources to focus the incident waves on a detector, wherein N≥1 and DOAs corresponding to the N signal sources are within a preset angle range; and
the detector comprising a plurality of detection areas, the preset angle range comprising a plurality of angle intervals, with each detection area corresponding to a respective angle interval; wherein the detector is configured to:
measure intensity of an electromagnetic field in the each detection area in response to the incident waves being focused on the detector to obtain an intensity measurement value of the electromagnetic field in the each detection area, and
determine the DOAs corresponding to the N signal sources based on angle intervals corresponding to N detection areas with greatest intensity measurement values.

2. The system according to claim 1, wherein each detection area in the detector is provided with a sub-detector configured to measure an intensity of an electromagnetic field in the detection area to which the sub-detector belongs;
the diffraction modulator comprises at least one layer of cascaded passive intelligent surface, the passive intelligent surface being configured to perform phase modulation on the incident waves in a transmission mode, and the passive intelligent surface being made by mixing polytetrafluoroethylene, nano-ceramics, and fiberglass fabric; or
the diffraction modulator comprises a reconfigurable intelligent surface and a first controller, the reconfigurable intelligent surface in the diffraction modulator being configured to perform phase modulation on the incident waves in a reflection mode, and the first controller being configured to apply a modulation voltage to the reconfigurable intelligent surface to realize the phase modulation of the incident waves.

3. The system according to claim 2, wherein based on that the diffraction modulator comprises the at least one layer of cascaded passive intelligent surface, the system further comprises:
a beamformer which comprising a reconfigurable intelligent surface and a second controller, the reconfigurable intelligent surface in the beamformer being configured to perform beamforming on the incident waves; and
the second controller, configured to:
determine a control voltage required for beamforming the incident waves emitted by the N signal sources based on the DOAs corresponding to the N signal sources and a direction angle corresponding to a signal receiver, and
apply the control voltage to the reconfigurable intelligent surface in the beamformer, whereby the reconfigurable intelligent surface in the beamformer beamforms the incident waves and reflects the beamformed incident waves to the signal receiver.

4. The system according to claim 2, wherein based on that the diffraction modulator comprises the reconfigurable intelligent surface and the first controller, the first controller is further configured to:
determine, based on the DOAs corresponding to the N signal sources and a direction angle corresponding to a signal receiver, a control voltage required for beamforming the incident waves emitted by the N signal sources, and apply the control voltage to the reconfigurable intelligent surface in the diffraction modulator, whereby the reconfigurable intelligent surface in the diffraction modulator beamforms the incident waves and reflects the beamformed incident waves to the signal receiver.

5. The system according to claim 1, wherein the DOAs corresponding to the N signal sources determined by the detector comprise intermediate values of the angle intervals corresponding to the N detection areas with the greatest intensity measurement values; and
the DOA comprises a pitch angle and/or an azimuth angle, and the system further switches between estimation of the pitch angle and estimation of the azimuth angle by controlling the diffraction modulator to rotate by 90°.

6. The system according to claim 1, wherein an angular resolution corresponding to the preset angle range is smaller than a diffraction limit angle, and the angular resolution represents a magnitude of one of the angle intervals.

7. A system for direction of arrival, DOA, estimation, comprising:
a diffraction modulator configured to modulate phase distribution of electromagnetic fields of incident waves emitted by N signal sources to focus the incident waves on a detector, wherein N≥1;
the detector comprising a plurality of detection areas, the detector being configured to measure an intensity of an electromagnetic field in each detection area in response to the incident waves being focused on the detector to obtain an intensity measurement value of the electromagnetic field in the each detection area, and send the intensity measurement value of the electromagnetic field in the each detection area to a controller; and
the controller configured to determine DOAs corresponding to the N signal sources based on the intensity measurement value of the electromagnetic field in the each detection area sent by the detector.

8. The system according to claim 7, wherein the DOAs corresponding to the N signal sources are within a preset angle range, the preset angle range comprising a plurality of angle intervals, with the each detection area corresponding to an angle interval; and
determining the DOAs corresponding to the N signal sources based on the intensity measurement value of the electromagnetic field in the each detection area sent by the detector comprises:
in response to N being 1, determining a greatest intensity measurement value and a second greatest intensity measurement value from the intensity measurement value of the electromagnetic field in the each detection area sent by the detector, and determining whether a detection area to which the greatest intensity measurement value belongs is adjacent to a detection area to which the second greatest intensity measurement value belongs; and
in response to the detection area to which the greatest intensity measurement value belongs being not adjacent to the detection area to which the second greatest intensity measurement value belongs, the DOAs corresponding to the N signal sources are determined based on an angle interval corresponding to the detection area to which the greatest intensity measurement value belongs.

9. The system according to claim 8, wherein determining the DOAs corresponding to the N signal sources based on the intensity measurement value of the electromagnetic field in each detection area sent by the detector comprises:
calculating an intensity ratio of the greatest intensity measurement value to the second greatest intensity measurement value in response to the detection area to which the greatest intensity measurement value belongs being adjacent to the detection area to which the second greatest intensity measurement value belongs; and
determining the DOAs corresponding to the N signal sources based on a relative magnitude between the intensity ratio and a preset decision coefficient, wherein the preset decision coefficient is obtained by calculating an intensity ratio between electromagnetic fields in adjacent detection areas corresponding to adjacent angle intervals in response to the DOAs of the incident waves being at an angle of intersection between the adjacent angle intervals.

10. The system according to claim 8, wherein the DOAs corresponding to the N signal sources comprise intermediate values of the angle intervals; and
an angular resolution corresponding to the preset angle range is smaller than a diffraction limit angle, and the angular resolution represents a magnitude of one of the angle intervals.

11. The system according to claim 7, wherein the DOAs corresponding to the N signal sources are within a preset angle range, the detector comprises K detection areas, with K≥N, K intensity-angle characteristic curves corresponding to the K detection areas are pre-stored in the controller, and a k-th intensity-angle characteristic curve is used to represent a mapping relationship between a plurality of prior DOAs within the preset angle range and prior intensity values of electromagnetic fields of the incident waves having respective prior DOAs in a k-th detection area, respectively, with k∈[1,K];
wherein determining the DOAs corresponding to the N signal sources based on the intensity measurement value of the electromagnetic field in the each detection area sent by the detector comprises:
for each prior DOA within the preset angle range, calculating error values between K prior intensity values corresponding to the each prior DOA on the K intensity-angle characteristic curves and intensity measurement values of the electromagnetic fields in the K detection areas sent by the detector to obtain an error value corresponding to the each prior DOA, and selecting N prior DOAs with the smallest error value as the DOAs corresponding to the N signal sources.

12. The system according to claim 7, wherein each detection area in the detector is provided with a detector configured to measure an intensity of an electromagnetic field in the detection area to which the detector belongs;
the diffraction modulator comprises at least one layer of cascaded passive intelligent surface, the passive intelligent surface being configured to perform phase modulation on the incident waves in a transmission mode, and the passive intelligent surface being made by mixing polytetrafluoroethylene, nano-ceramics, and fiberglass fabric; or
the diffraction modulator comprises a reconfigurable intelligent surface, the reconfigurable intelligent surface in the diffraction modulator being configured to perform phase modulation on the incident waves in a reflection mode.

13. The system according to claim 12, wherein based on that the diffraction modulator comprises the at least one layer of cascaded passive intelligent surface, the system further comprises:
a beamformer comprising a reconfigurable intelligent surface, the reconfigurable intelligent surface in the beamformer being configured to perform beamforming on the incident waves; and
wherein the controller is further configured to determine a control voltage required for beamforming the incident waves emitted by the N signal sources based on the DOAs corresponding to the N signal sources and a direction angle corresponding to a signal receiver, and apply the control voltage to the reconfigurable intelligent surface in the beamformer, whereby the reconfigurable intelligent surface in the beamformer beamforms the incident waves and reflects the beamformed incident waves to the signal receiver.

14. The system according to claim 12, wherein based on that the diffraction modulator comprises a reconfigurable intelligent surface, the controller is further configured to:
apply a modulation voltage to the reconfigurable intelligent surface in the diffraction modulator to realize phase modulation of the incident waves; and/or
determine a control voltage required for beamforming the incident waves emitted by the N signal sources based on the DOAs corresponding to the N signal sources and a direction angle corresponding to a signal receiver, and apply the control voltage to the reconfigurable intelligent surface in the diffraction modulator, whereby the reconfigurable intelligent surface in the diffraction modulator beamforms the incident waves and reflects the beamformed incident waves to the signal receiver.

15. The system according to claim 7, wherein the DOA comprises a pitch angle and/or an azimuth angle, and the controller is further configured to control the diffraction modulator to rotate by 90° to switch between estimation of the pitch angle and estimation of the azimuth angle.

16. A device, comprising:
a first DOA estimation system configured to estimate DOAs in I angle intervals of a preset angle range, with I being a positive integer; and
I second DOA estimation systems, wherein an i-th second DOA estimation system is configured to estimate DOAs in J sub-angle intervals of an i-th angle interval in the I angle intervals, with i∈[1, I] and J being a positive integer,
wherein the first DOA estimation system and at least one of the I second DOA estimation systems respectively comprise:
a diffraction modulator configured to modulate phase distribution of electromagnetic fields of incident waves emitted by N signal sources to focus the incident waves on a detector, wherein N≥1 and DOAs corresponding to the N signal sources are within a preset angle range; and
the detector comprising a plurality of detection areas, the preset angle range comprising a plurality of angle intervals, with each detection area corresponding to an angle interval; and the detector being configured to measure intensity of an electromagnetic field in the each detection area in response to the incident waves being focused on the detector to obtain an intensity measurement value of the electromagnetic field in the each detection area, and determine the DOAs corresponding to the N signal sources based on angle intervals corresponding to N detection areas with greatest intensity measurement values;
or respectively comprise:
a direction of arrival, DOA, estimation system comprising:
a diffraction modulator configured to modulate phase distribution of electromagnetic fields of incident waves emitted by N signal sources to focus the incident waves on a detector, wherein N≥1;
the detector comprising a plurality of detection areas, the detector being configured to measure an intensity of an electromagnetic field in each detection area in response to the incident waves being focused on the detector to obtain an intensity measurement value of the electromagnetic field in the each detection area, and send the intensity measurement value of the electromagnetic field in the each detection area to a controller; and
the controller, configured to determine DOAs corresponding to the N signal sources based on the intensity measurement value of the electromagnetic field in the each detection area sent by the detector.

17. The device according to claim 16, wherein
the first DOA estimation system is configured to control an m-th second DOA estimation system for estimating a DOA in an m-th angle interval to perform DOA estimation in response to estimating that a DOA corresponding to a signal source belongs to the m-th angle interval, with m∈[1, i]; and
the m-th second DOA estimation system is configured to determine a sub-angle interval to which the DOA corresponding to the signal source belongs, and determine the DOA corresponding to the signal source based on the sub-angle interval to which the DOA corresponding to the signal source belongs.

18. The device according to claim 16, wherein a magnitude of one of the I angle intervals is greater than or equal to a diffraction limit angle, and a magnitude of one of the J sub-angle intervals is less than the diffraction limit angle.
